(19) United States
(12) Patent Application Publication
(10) Pub. No.: US 2013/0260042 A1
(43) Pub. Date: Oct. 3, 2013

(54) EPOXY-BASED COATING COMPOSITIONS

(71) Applicants: Christopher J. Campbell, Burnsville, MN (US); Stuart E. Fores, Darlington (GB); John C. Hulteen, Afton, MN (US); Ian Robinson, Northallerton (GB)

(72) Inventors: Christopher J. Campbell, Burnsville, MN (US); Stuart E. Fores, Darlington (GB); John C. Hulteen, Afton, MN (US); Ian Robinson, Northallerton (GB)

(21) Appl. No.: 13/990,008

(22) PCT Filed: Nov. 17, 2011
(86) PCT No.: PCT/US2011/061116

§ 371 Date: May 28, 2013

Related U.S. Application Data
(60) Provisional application No. 61/426,006, filed on Dec. 22, 2010.

(51) Int. Cl. C09D 163/04

(52) U.S. Cl. CPC C09D 163/04
USPC 427/386; 523/400; 523/466

(57) ABSTRACT

Curable and cured epoxy-based coating compositions are described. The curable coating compositions are typically two-part epoxy-based formulations. The cured coating composition can be used in various applications such as those in which the curable coating composition is applied to either a clean surface or to a surface contaminated with a hydrocarbon-containing material. The cured coating composition typically bonds effectively to the substrate even in the presence of a hydrocarbon-containing material.

### CROSS REFERENCE TO RELATED APPLICATION

This application claims the benefit of U.S. Provisional Patent Application No. 61/426,006, filed Dec. 22, 2010, the disclosure of which is incorporated by reference herein in its entirety

### TECHNICAL FIELD

Curable and cured epoxy-based coating compositions as well as articles that include the epoxy-based coating compositions are described.

### BACKGROUND

Coating compositions sometimes need to be applied to substrates that may be contaminated with a hydrocarbon-containing material such as various oils and lubricants. Oil and lubricant contamination is not uncommon on substrates that are part of a vehicle such as an automobile, oil storage tanks, engine room surfaces, and the like. The presence of this contamination can prevent good bonding of coatings to substrates.

Removing hydrocarbon-containing materials from the surfaces of substrates can be difficult. Mechanical processes such as dry wiping and/or using pressurized air tend to leave a thin layer of the hydrocarbon-containing material on the surfaces. Liquid cleaning compositions can be effective but these compositions typically need to be collected and recycled or discarded. Additionally, a drying step is typically needed after the cleaning step.

Some adhesive compositions are known that can be used without removing all of the hydrocarbon-containing materials from the surface of the substrate to which the adhesive is applied. Examples include PCT patent application publications WO 2010/011710 A2 (Campbell et al.), WO 2010/039614 A2 (Kolowrot et al.), and WO 2009/059007 A2 (Pressley et al.).

### SUMMARY

Curable and cured epoxy-based coating compositions are described. The curable coating compositions are typically two-part epoxy-based formulations. The cured coating composition can be used in various applications such as those in which the curable coating composition is applied to either a clean surface or to a surface contaminated with a hydrocarbon-containing material. The cured coating composition typically bonds effectively to the substrate even in the presence of the hydrocarbon-containing material.

In a first aspect, a curable coating composition is provided that has a first part and a second part. The curable coating composition contains a) an epoxy resin in the first part of the curable coating composition, b) a curing agent in the second part of the curable coating composition, c) an oil displacing agent, d) an oil absorbing fiber, and e) an optional toughening agent. The curing agent has at least two amino groups of formula —NR¹H where R¹ is hydrogen, alkyl, aryl, or aralkyl. The oil displacing agent is soluble in the curable coating composition, has a surface tension in a range of 15 to 32 dynes/cm, and has a boiling point of at least 200° C. The oil absorbing fiber contains 0 to 50 weight percent fibrillated organic fiber based on a total weight of oil absorbing fiber in the curable coating composition. The toughening agent, if present, is a liquid at temperatures in a range of 20° C. to 30° C. and is present in a concentration range of 0 to 5 weight percent based on a total weight of the curable coating composition.

In a second aspect, a cured coating composition is provided that contains a reaction product of a curable coating composition. The curable coating composition contains a) an epoxy resin, b) a curing agent, c) an oil displacing agent, d) an oil absorbing fiber, and e) an optional toughening agent. The curing agent has at least two amino groups of formula —NR¹H where R¹ is hydrogen, alkyl, aryl, or aralkyl. The oil displacing agent is soluble in the curable coating composition, has a surface tension in a range of 15 to 32 dynes/cm, and has a boiling point of at least 200° C. The oil absorbing fiber contains 0 to 50 weight percent fibrillated organic fiber based on a total weight of oil absorbing fiber in the curable coating composition. The toughening agent, if present, is a liquid at temperatures in a range of 20° C. to 30° C. and is present in a concentration range of 0 to 5 weight percent based on a total weight of the curable coating composition.

In a third aspect, an article is provided. The article includes 1) a substrate and 2) a cured coating composition that is adjacent to the substrate and that contains a reaction product of a curable coating composition. The curable coating composition contains a) an epoxy resin, b) a curing agent, c) an oil displacing agent, d) an oil absorbing fiber, and e) an optional toughening agent. The curing agent has at least two amino groups of formula —NR¹H where R¹ is hydrogen, alkyl, aryl, or aralkyl. The oil displacing agent is soluble in the curable coating composition, has a surface tension in a range of 15 to 32 dynes/cm, and has a boiling point of at least 200° C. The oil absorbing fiber contains 0 to 50 weight percent fibrillated organic fiber based on a total weight of oil absorbing fiber in the curable coating composition. The toughening agent, if present, is a liquid at temperatures in a range of 20° C. to 30° C. and is present in a concentration range of 0 to 5 weight percent based on a total weight of the curable coating composition.

In a fourth aspect, a method of coating a substrate is provided. The method includes providing a substrate and applying a curable coating composition adjacent to the substrate. The curable coating composition contains a) an epoxy resin, b) a curing agent, c) an oil displacing agent, d) an oil absorbing fiber, and e) an optional toughening agent. The curing agent has at least two amino groups of formula —NR¹H where R¹ is hydrogen, alkyl, aryl, or aralkyl. The oil displacing agent is soluble in the curable coating composition, has a surface tension in a range of 15 to 32 dynes/cm, and has a boiling point of at least 200° C. The oil absorbing fiber contains 0 to 50 weight percent fibrillated organic fiber based on a total weight of oil absorbing fiber in the curable coating composition. The toughening agent, if present, is a liquid at temperatures in a range of 20° C. to 30° C. and is present in a concentration range of 0 to 5 weight percent based on a total weight of the curable coating composition. The method further includes curing the curable coating composition to provide a cured coating composition adjacent to the substrate.

The above summary of the present invention is not intended to describe each embodiment or every implementation of the present invention. The Detailed Description and Examples that follow more particularly exemplify these embodiments.

### DETAILED DESCRIPTION OF THE INVENTION

Curable coating compositions and cured coating compositions that are reaction products of the curable coating compositions are described. More specifically, the curable coating compositions contain a) an epoxy resin, b) a curing agent, c) an oil displacing agent, d) an oil absorbing fiber, and e) an optional toughening agent. The curable coating compositions are typically applied to at least one surface of a substrate and then cured. The at least one surface of the substrate can be clean or can be contaminated with a hydrocarbon-containing material.

The curable coating compositions are often in the form of a two-part composition. The epoxy resin is typically separated from the curing agent prior to use of the curable coating composition. That is, the epoxy resin is typically in a first part and the curing agent is typically in a second part of the curable coating composition. The first part can include other components that do not react with the epoxy resin or that react with only a portion of the epoxy resin. Likewise, the second part can include other components that do not react with the curing agent or that react with only a portion of the curing agent. The oil displacing agent, the oil absorbing fiber, and the optional toughening agent can be included in the first part, in the second part, in both the first part and the second part, or in a third part. When the various parts are mixed together, the components react to form the cured coating composition.

The epoxy resin that is included in the first part of the curable coating composition contains at least one epoxy functional group (i.e., oxirane group) per molecule. As used herein, the term oxirane group refers to the following divalent group.

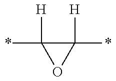 [SMILES: *C1OC1*]

The asterisks denote a site of attachment of the oxirane group to another group. If the oxirane group is at the terminal position of the epoxy resin, the oxirane group is typically bonded to a hydrogen atom.

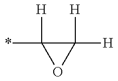 [SMILES: *C1CO1]

This terminal oxirane group is often part of a glycidyl group.

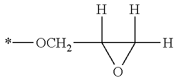

The epoxy resin has at least one oxirane group per molecule and often has at least two oxirane groups per molecule. For example, the epoxy resin can have 1 to 10, 2 to 10, 1 to 6, 2 to 6, 1 to 4, or 2 to 4 oxirane groups per molecule. The oxirane groups are usually part of a glycidyl group.

Epoxy resins can be a single material or a mixture of materials selected to provide the desired viscosity characteristics before curing and to provide the desired mechanical properties after curing. If the epoxy resin is a mixture of materials, at least one of the epoxy resins in the mixture is usually selected to have at least two oxirane groups per molecule. For example, a first epoxy resin in the mixture can have two to four or more oxirane groups and a second epoxy resin in the mixture can have one to four oxirane groups. In some of these examples, the first epoxy resin is a first glycidyl ether with two to four glycidyl groups and the second epoxy resin is a second glycidyl ether with one to four glycidyl groups.

The portion of the epoxy resin molecule that is not an oxirane group (i.e., the epoxy resin molecule minus the oxirane groups) can be aromatic, aliphatic or a combination thereof and can be linear, branched, cyclic, or a combination thereof. The aromatic and aliphatic portions of the epoxy resin can include heteroatoms or other groups that are not reactive with the oxirane groups. That is, the epoxy resin can include halo groups, oxy groups such as in an ether linkage group, thio groups such as in a thio ether linkage group, carbonyl groups, carbonyloxy groups, carbonylimino groups, phosphono groups, sulfono groups, nitro groups, nitrile groups, and the like. The epoxy resin can also be a silicone-based material such as a polydiorganosiloxane-based material.

Although the epoxy resin can have any suitable molecular weight, the weight average molecular weight is usually at least 100 grams/mole, at least 150 grams/mole, at least 175 grams/mole, at least 200 grams/mole, at least 250 grams/mole, or at least 300 grams/mole. The weight average molecular weight can be up to 50,000 gram/mole or even higher for polymeric epoxy resins. The weight average molecular weight is often up to 40,000 grams/mole, up to 20,000 grams/mole, up to 10,000 grams/mole, up to 5,000 grams/mole, up to 3,000 grams/mole, or up to 1,000 grams/mole. For example, the weight average molecular weight can be in the range of 100 to 50,000 grams/mole, in the range of 100 to 20,000 grams/mole, in the range of 10 to 10,000 grams/mole, in the range of 100 to 5,000 grams/mole, in the range of 200 to 5,000 grams/mole, in the range of 100 to 2,000 grams/mole, in the range of 200 to 2,000 gram/mole, in the range of 100 to 1,000 grams/mole, or in the range of 200 to 1,000 grams/mole.

Suitable epoxy resins are typically a liquid at room temperature (e.g., about 20° C. to about 25° C. or about 20° C. to about 30° C.). However, epoxy resins that can be dissolved in a suitable organic solvent also can be used. In most embodiments, the epoxy resin is a glycidyl ether. Exemplary glycidyl ethers can be of Formula (I).

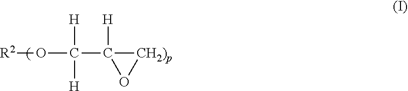

In Formula (I), group R² is a p-valent group that is aromatic, aliphatic, or a combination thereof. Group R² can be linear, branched, cyclic, or a combination thereof. Group R² can optionally include halo groups, oxy groups, thio groups, carbonyl groups, carbonyloxy groups, carbonylimino groups, phosphono groups, sulfono groups, nitro groups, nitrile groups, and the like. Although the variable p can be any suitable integer greater than or equal to 1, p is often an integer in the range of 2 to 10, in the range of 2 to 6, or in the range of 2 to 4.

In some exemplary epoxy resins of Formula (I), the variable p is equal to 2 (i.e., the epoxy resin is a diglycidyl ether) and R² includes an alkylene (i.e., an alkylene is a divalent radical of an alkane and can be referred to as an alkane-diyl), heteroalkylene (i.e., a heteroalkylene is a divalent radical of a heteroalkane and can be referred to as a heteroalkane-diyl), arylene (i.e., a divalent radical of a arene compound), or combination thereof. Suitable alkylene groups often have 1 to 20 carbon atoms, 1 to 12 carbon atoms, 1 to 8 carbon atoms, or 1 to 4 carbon atoms. Suitable heteroalkylene groups often have 2 to 50 carbon atoms, 2 to 40 carbon atoms, 2 to 30 carbon atoms, 2 to 20 carbon atoms, 2 to 10 carbon atoms, or 2 to 6 carbon atoms with 1 to 10 heteroatoms, 1 to 6 heteroatoms, or 1 to 4 heteroatoms. The heteroatoms in the heteroalkylene can be selected from oxy, thio, or —NH— groups but are often oxy groups. Suitable arylene groups often have 6 to 18 carbon atoms or 6 to 12 carbon atoms. For example, the arylene can be phenylene or biphenylene. Group R² can further optionally include halo groups, oxy groups, thio groups, carbonyl groups, carbonyloxy groups, carbonylimino groups, phosphono groups, sulfono groups, nitro groups, nitrile groups, and the like. The variable p is usually an integer in the range of 2 to 4.

Some epoxy resins of Formula (I) are diglycidyl ethers where R² includes (a) an arylene group or (b) an arylene group in combination with an alkylene, heteroalkylene, or both. Group R² can further include optional groups such as halo groups, oxy groups, thio groups, carbonyl groups, carbonyloxy groups, carbonylimino groups, phosphono groups, sulfono groups, nitro groups, nitrile groups, and the like. These epoxy resins can be prepared, for example, by reacting an aromatic compound having at least two hydroxyl groups with an excess of epichlorohydrin. Examples of useful aromatic compounds having at least two hydroxyl groups include, but are not limited to, resorcinol, catechol, hydroquinone, p,p′-dihydroxydibenzyl, p,p′-dihydroxyphenylsulfone, p,p′-dihydroxybenzophenone, 2,2′-dihydroxyphenyl sulfone, and p,p′-dihydroxybenzophenone. Still other examples include the 2,2′,2,3′,2,4′,3,3′,3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Some commercially available diglycidyl ether epoxy resins of Formula (I) are derived from bisphenol A (i.e., bisphenol A is 4,4′-dihydroxydiphenylmethane). Examples include, but are not limited to, those available under the trade designation EPON (e.g., EPON 828, EPON 872, and EPON 1001) from Hexion Specialty Chemicals, Inc. in Houston, Tex., those available under the trade designation DER (e.g., DER 331, DER 332, and DER 336) from Dow Chemical Co. in Midland, Mich., and those available under the trade designation EPICLON (e.g., EPICLON 850) from Dainippon Ink and Chemicals, Inc. in Chiba, Japan. Other commercially available diglycidyl ether epoxy resins are derived from bisphenol F (i.e., bisphenol F is 2,2′-dihydroxydiphenylmethane). Examples include, but are not limited to, those available under the trade designation DER (e.g., DER 334) from Dow Chemical Co. and those available under the trade designation EPICLON (e.g., EPICLON 830) from Dainippon Ink and Chemicals, Inc.

Other epoxy resins of Formula (I) are diglycidyl ethers of a poly(alkylene oxide) diol. These epoxy resins also can be referred to as diglycidyl ethers of a poly(alkylene glycol) diol. The variable p is equal to 2 and R² is a heteroalkylene having oxygen heteroatoms. The poly(alkylene glycol) portion can be a copolymer or homopolymer and often include alkylene units having 1 to 4 carbon atoms. Examples include, but are not limited to, diglycidyl ethers of poly(ethylene oxide) diol, diglycidyl ethers of poly(propylene oxide) diol, and diglycidyl ethers of poly(tetramethylene oxide) diol. Epoxy resins of this type are commercially available from Polysciences, Inc. in Warrington, Pa. such as those derived from a poly(ethylene oxide) diol or from a poly(propylene oxide) diol having a weight average molecular weight of about 400 grams/mole, about 600 grams/mole, or about 1000 gram/mole.

Still other epoxy resins of Formula (I) are diglycidyl ethers of an alkane diol (R² is an alkylene and the variable p is equal to 2). Examples include a diglycidyl ether of 1,4-dimethanol cylcohexyl, diglycidyl ether of 1,4-butanediol, and a diglycidyl ether of the cycloaliphatic diol formed from a hydrogenated bisphenol A such as those commercially available under the trade designation EPONEX (e.g., EPONEX 1510 from Hexion Specialty Chemicals, Inc. of Columbus, Ohio and under the trade designation EPALLOY (e.g., EPALLLOY 5001) from CVC Thermoset Specialties in Moorestown, N.J.

For some applications, the epoxy resins chosen for use in the curable coating compositions are novolac epoxy resins, which are glycidyl ethers of phenolic novolac resins. These resins can be prepared, for example, by reaction of phenols with an excess of formaldehyde in the presence of an acidic catalyst to produce the phenolic novolac resin. Novolac epoxy resins are then prepared by reacting the phenolic novolac resin with epichlorihydrin in the presence of sodium hydroxide. The resulting novolac epoxy resins typically have more than two oxirane groups and can be used to produce cured coating compositions with a high crosslinking density. The use of novolac epoxy resins can be particularly desirable in applications where corrosion resistance, water resistance, chemical resistance, or a combination thereof is desired. One such novolac epoxy resin is poly[(phenyl glycidyl ether)-co-formaldehyde]. Other suitable novolac resins are commercially available under the trade designation ARALDITE (e.g., ARALDITE GY289, ARALDITE EPN 1183, ARALDITE EP 1179, ARALDITE EPN 1139, and ARALDITE EPN 1138) from Huntsman Advanced Materials in The Woodlands, Tex., under the trade designation EPALLOY (e.g., EPALLOY 8230) from CVC Thermoset Specialties in Moorestown, N.J., and under the trade designation DEN (e.g., DEN 424 and DEN 431) from Dow Chemical in Midland, Mich.

Yet other epoxy resins include silicone resins with at least two glycidyl groups and flame retardant epoxy resins with at least two glycidyl groups (e.g., a brominated bisphenol-type epoxy resin having with at least two glycidyl groups such as that commercially available from Dow Chemical Co. in Midland, Mich. under the trade designation DER 580).

The epoxy resin is often a mixture of materials. For example, the epoxy resins can be selected to be a mixture that provides the desired viscosity or flow characteristics prior to curing. The mixture can include at least one first epoxy resin that is referred to as a reactive diluent that has a lower viscosity and at least one second epoxy resin that has a higher viscosity. The reactive diluent tends to lower the viscosity of the epoxy resin composition and often has either a branched backbone that is saturated or a cyclic backbone that is saturated or unsaturated. Examples include, but are not limited to, the diglycidyl ether of resorcinol, the diglycidyl ether of cyclohexane dimethanol, the diglycidyl ether of neopentyl glycol, and the triglycidyl ether of trimethylolpropane. Diglycidyl ethers of cyclohexane dimethanol are commercially available under the trade designation HELOXY MODIFIER (e.g., HELOXY MODIFIER 107) from Hexion Specialty Chemicals in Columbus, Ohio and under the trade designation EPODIL (e.g., EPODIL 757) from Air Products and Chemical Inc. in Allentonwn, Pa. Other reactive diluents have only one functional group (i.e., oxirane group) such as various monoglycidyl ethers. Some example monoglycidyl ethers include, but are not limited to, alkyl glycidyl ethers with an alkyl group having 1 to 20 carbon atoms, 1 to 12 carbon atoms, 1 to 8 carbon atoms, or 1 to 4 carbon atoms. Some monoglycidyl ethers that are commercially available include those under the trade designation EPODIL from Air Products and Chemical, Inc. in Allentown, Pa. such as EPODIL 746 (2-ethylhexyl glycidyl ether), EPODIL 747 (aliphatic glycidyl ether), and EPODIL 748 (aliphatic glycidyl ether).

Still other epoxy resins are designed to reduce amine blushing. These epoxy resins are usually added into the curable coating compositions at relatively low levels. Such an epoxy resin is commercially available under the trade designation added DW 1765 from Huntsman Advanced Materials, The Woodlands, Tex. This material has a paste-like consistency but is based on a liquid epoxy resin.

In most embodiments, the epoxy resin includes one or more glycidyl ethers and does not include epoxy esters. Epoxy esters can be included in the curable coating compositions, however, as oil displacing agents.

The curable coating composition typically includes at least 20 weight percent epoxy resin based on a combined weight of the first part and the second part of the curable coating composition (i.e., based on a total weight of the curable coating composition). If lower levels are used, the cured coating composition may not contain enough polymeric material (e.g., epoxy resin) to provide the desired coating characteristics. Some curable coating composition can include at least 25 weight percent, at least 30 weight percent, at least 40 weight percent, or at least 50 weight percent epoxy resin. The curable coating composition often includes up to 80 weight percent epoxy resin. For example, the curable coating composition can include up to 75 weight percent, up to 70 weight percent, up to 65 weight percent, or up to 60 weight percent epoxy resin. Some example curable coating compositions contain 20 to 80 weight percent, 20 to 70 weight percent, 30 to 90 weight percent, 30 to 80 weight percent, 30 to 70 weight percent, 30 to 60 weight percent, 40 to 90 weight percent, 40 to 80 weight percent, 40 to 70 weight percent, 40 to 60 weight percent, 50 to 80 weight percent, or 50 to 70 weight percent epoxy resin.

The epoxy resin is cured by reacting with a curing agent that is typically in a second part of the curable coating composition. Stated differently, the epoxy resin is typically separated from the curing agent during storage or prior to using the curable coating composition. The curing agent has at least two primary amino groups, at least two secondary amino groups, or combinations thereof. That is, the curing agent has at least two groups of formula —NR¹H where R¹ is selected from hydrogen, alkyl, aryl, or alkylaryl. Suitable alkyl groups often have 1 to 12 carbon atoms, 1 to 8 carbon atoms, 1 to 6 carbon atoms, or 1 to 4 carbon atoms. The alkyl group can be cyclic, branched, linear, or a combination thereof. Suitable aryl groups usually have 6 to 12 carbon atom such as a phenyl or biphenyl group. Suitable alkylaryl groups can be either an alkyl substituted with an aryl or an aryl substituted with an alkyl. The same aryl and alkyl groups discussed above can be used in the alkylaryl groups.

When the first part and the second part of the curable coating composition are mixed together, the primary and/or secondary amino groups of the curing agent react with the oxirane groups of the epoxy resin. This reaction opens the oxirane groups and covalently bonds the curing agent to the epoxy resin. The reaction results in the formation of divalent groups of formula —OCH₂—CH₂—NR¹— where R¹ is equal to hydrogen, alkyl, aryl, or alkylaryl.

The curing agent minus the at least two amino groups (i.e., the portion of the curing agent that is not an amino group) can be any suitable aromatic group, aliphatic group, or combination thereof. Some amine curing agents are of Formula (II) with the additional limitation that there are at least two primary amino groups, at least two secondary amino groups, or at least one primary amino group and at least one secondary amino group.

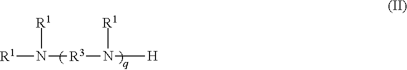

Each R¹ group is independently hydrogen, alkyl, aryl, or alkylaryl. Suitable alkyl groups for R¹ often have 1 to 12 carbon atoms, 1 to 8 carbon atoms, 1 to 6 carbon atoms, or 1 to 4 carbon atoms. The alkyl group can be cyclic, branched, linear, or a combination thereof. Suitable aryl groups for R¹ often have 6 to 12 carbon atoms such as a phenyl or biphenyl group. Suitable alkylaryl groups for R¹ can be either an alkyl substituted with an aryl or an aryl substituted with an alkyl. The same aryl and alkyl groups discussed above can be used in the alkylaryl groups. Each R³ is independently an alkylene, heteroalkylene, or combination thereof. Suitable alkylene groups often have 1 to 18 carbon atoms, 1 to 12 carbon atoms, 1 to 8 carbon atoms, 1 to 6 carbon atoms, or 1 to 4 carbon atoms. Suitable heteroalkylene groups have at least one oxy, thio, or —NH— group positioned between two alkylene groups. Suitable heteroalkylene groups often have 2 to 50 carbon atoms, 2 to 40 carbon atoms, 2 to 30 carbon atoms, 2 to 20 carbon atoms, or 2 to 10 carbon atoms and up to 20 heteroatoms, up to 16 heteroatoms, up to 12 heteroatoms, or up to 10 heteroatoms. The heteroatoms are often oxy groups. The variable q is an integer equal to at least one and can be up to 10 or higher, up to 5, up to 4, or up to 3.

Some amine curing agents can have an R³ group selected from an alkylene group. Examples include, but are not limited to, ethylene diamine, diethylene diamine, diethylene triamine, triethylene tetramine, propylene diamine, tetraethylene pentamine, hexaethylene heptamine, hexamethylene diamine, 2-methyl-1,5-pentamethylene diamine, 1-amino-3-aminomethyl-3,3,5-trimethylcyclohexane (also called isophorene diamine), 1,3 bis-aminomethyl cyclohexane, and the like. Other amine curing agents can have an R³ group selected from a heteroalkylene group such as a heteroalkylene having oxygen heteroatoms. For example, the curing agent can be a compound such as aminoethylpiperazine, 4,7,10-trioxamidecane-1,13-diamine (TTD) available from TCI America in Portland, Oreg., or a poly(alkylene oxide) diamine (also called polyether diamines) such as a poly(ethylene oxide) diamine, poly(propylene oxide) diamine, or a copolymer thereof. Commercially available polyether diamines are commercially available under the trade designation JEFFAMINE form Huntsman Corporation in The Woodlands, Tex.

Still other amine curing agents can be formed by reacting a polyamine (i.e., a polyamine refers to an amine with at least two amino groups selected from primary amino groups and secondary amino groups) with another reactant to form an amine-containing adduct having at least two amino groups. For example, a polyamine can be reacted with an epoxy resin to form an adduct having at least two amino groups. If a polymeric diamine is reacted with a dicarboxylic acid in a molar ratio of diamine to dicarboxylic acid that is greater than or equal to 2:1, a polyamidoamine having two amino groups can be formed. In another example, if a polymeric diamine is reacted with an epoxy resin having two glycidyl groups in a molar ratio of diamine to epoxy resin greater than or equal to 2:1, an amine-containing adduct having two amino groups can be formed. Such a polyamidoamine can be prepared as described, for example, in U.S. Pat. No. 5,629,380 (Baldwin et al.). A molar excess of the polymeric diamine is often used so that the curing agent includes both the amine-containing adduct plus free (non-reacted) polymeric diamine. For example, the molar ratio of diamine to epoxy resin with two glycidyl groups can be greater than 2.5:1, greater than 3:1, greater than 3.5:1, or greater than 4:1. Even when epoxy resin is used to form the amine-containing adduct in the second part of the curable coating composition, additional epoxy resin is present in the first part of the curable coating composition.

The curing agent can also be an aromatic ring substituted with multiple amino groups or with amino-containing groups. Such curing agents include, but are not limited to, xylene diamines (e.g., meta-xylene diamine) or similar compounds. For example, one such curing agent is commercially available under the trade designation ANCAMINE (e.g., ANCAMINE 2609) from Air Products in Allentown, Pa. and under the trade designation ARADUR 2965 from Huntsman Advanced Materials, The Woodlands, Tex. This particular curing agent is based on meta-xylene diamine.

The curing agent can be a mixture of materials. For example, the curing agent can include a first curing agent that is a polymeric material added to enhance flexibility of the cured coating composition plus a second curing agent that is added to alter the glass transition temperature of the cured coating composition.

The curable coating compositions usually contain at least 5 weight percent curing agent based on a total weight of the curable coating composition. For example, the total curable coating composition can contain at least 5 weight percent, or at least 10 weight percent of the curing agent. The adhesive composition typically includes up to 60 weight percent, up to 50 weight percent, up to 40 weight percent, or up to 30 weight percent of the curing agent. For example, the curable coating composition can contain 5 to 60 weight percent, 10 to 60 weight percent, 20 to 60 weight percent, 10 to 40 weight percent, 20 to 40 weight percent, 10 to 30 weight percent, 20 to 30 weight percent of the curing agent.

Other curing agents can be included in the curable coating composition. These other curing agents are typically considered to be secondary curatives because, compared to curing agents having at least two groups of formula —NHR¹, they are not as reactive with the oxarine rings of the epoxy resins at room temperature. Secondary curatives are often imidizoles or salts thereof, imidazolines or salts thereof, or phenols substituted with tertiary amino groups. Suitable phenols substituted with tertiary amino groups can be of Formula (III).

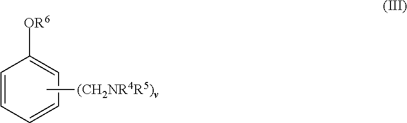

In Formula (III), each group R⁴ and R⁵ is independently an alkyl. The variable v is an integer equal to 2 or 3. Group R⁶ is hydrogen or alkyl. Suitable alkyl groups for R⁴, R⁵, and R⁶ often have 1 to 12 carbon atoms, 1 to 8 carbon atoms, 1 to 6 carbon atoms, or 1 to 4 carbon atoms. One exemplary secondary curative of Formula (IV) is tris-2,4,6-(dimethylaminomethyl)phenol that is commercially available under the trade designation ANCAMINE K54 from Air Products Chemicals, Inc. of Allentown, Pa.

The optional secondary curative can be present in the first part of the curable coating composition with the epoxy resin, in the second part of the curable coating composition with the curing agent, or in both the first and second parts. The amount of the secondary curative is typically up to 6 weight percent, up to 5 weight percent, or up to 4 weight percent base on a total weight of the curable coating composition. If included in the first part (epoxy part), the secondary curative can be present in an amount in the range of 0 to 15 weight percent, in the range of 0.5 to 10 weight percent, or in the range of 1 to 5 weight percent based on a total weight of the first part. If included in the second part (curing agent part), the secondary curative can be present in an amount in the range of 0 to 5 weight percent, in the range of 0.5 to 5 weight percent, or in the range of 1 to 5 percent based on a total weight of the second part.

The curing reaction can occur at ambient temperature or higher. In some applications, the curing occurs at an elevated temperature (e.g., temperatures above 100° C. or above 120° C. or above 150° C.). The ratio of amine hydrogen equivalent weight to epoxy equivalent weight is often selected to be close to 1:1 (e.g., 1.2:1 to 1:1.2, 1.1:1 to 1:1.1, or 1.05:1 to 1:1.05. Excess amine can result in amine blushing. That is, the amine compound can migrate to the surface of the coating and form carbamates. This can result in a noticeable defect in the coating. A second coating applied over a first coating with such defects may not adhere sufficiently. Excess epoxy groups, however, can lead to water adsorption that can result in chemical degradation of the cured coating, corrosion of the underlying substrate, or both.

The curable coating compositions further include an oil displacing agent. The oil displacing agent typically does not react with either the epoxy resin or the curing agent. As such, the oil displacing agent can be in the first part, in the second part, or in both the first and second parts of the curable coating composition. The oil displacing agent is selected to be soluble in the curable coating composition, to have a surface tension in a range of 15 to 32 dynes/cm, and to have a boiling point equal to at least 200° C.

The addition of the oil displacing agent is particularly advantageous for coating compositions that are positioned adjacent to a substrate that may be contaminated with a hydrocarbon-containing material. As used herein, the term “hydrocarbon-containing material” refers to a variety of substances that can contaminate the surface of the substrate during processing, handling, storage, or combinations thereof. Examples of hydrocarbon-containing materials include, but are not limited to, mineral oils, fats, dry lubricants, deep drawing oils, corrosion protection agents, lubricating agents, waxes, and the like. The surface of the substrate may contain other contaminants in addition to the hydrocarbon-containing material. While not wishing to be bound by theory, the oil displacing agent may facilitate transfer of the hydrocarbon-containing away from the surface of the substrate and into the bulk of the curable coating composition. This transfer away from the surface of the substrate may result in improved adhesion of the coating composition to the substrate surface.

The oil displacing agents are usually liquids at room temperature. These agents are typically capable of disrupting or displacing hydrocarbon-containing material at the surface of the substrate while remaining miscible both with the curable coating composition during application and with the resulting cured coating composition. Suitable oil displacing agents often have a surface tension that is lower than that of the hydrocarbon-containing material and a solubility parameter similar to that of the hydrocarbon-containing material.

The oil displacing agents usually have a surface tension up to 35 dynes per centimeter (dynes/cm). For example, the surface tension can be up to 35 dynes/cm, up to 32 dynes/cm, up to 30 dynes/cm, or up to 25 dynes/cm. The surface tension is often at least 15 dynes/cm, at least 18 dynes/cm, or at least 20 dynes/cm. For example, the surface tension can be in the range of 15 to 35 dynes/cm, in the range of 15 to 32 dynes/cm, in the range of 15 to 30 dynes/cm, in the range of 20 to 35 dynes/cm, in the range of 20 to 30 dynes/cm, in the range of 25 to 35 dynes/cm, or in the range of 25 to 30 dynes/cm. The surface tension can be measured, for example, using the so-called pendant drop test (also referred to as the pendant drop shape analysis method) as specified in an article by F. K. Hansen et al. (J. Coll. and Inter. Sci., 141, 1-12 (1991)).

If the hydrocarbon-containing material on the surface of the substrate is known, the oil displacing agent can be selected to have a surface tension that is less than the surface tension of the hydrocarbon-containing material. More specifically, the oil displacing agent can be selected to have a surface tension that is at least 2.5 dynes/cm less than that of the hydrocarbon-containing material. For example, the surface tension of the oil displacing agent can be at least 4.0 dynes/cm less than, at least 8.0 dynes/cm less than, or at least 12.0 dynes/cm less than that of the hydrocarbon-containing material.

In many embodiments, the solubility parameter of the oil displacing agent is in the range of 6 to 12 cal^{0.5}/cm^{1.5}. For example, the solubility parameter can be in the range of 7 to 12 cal^{0.5}/cm^{1.5}, in the range of 8 to 12 cal^{0.5}/cm^{1.5}, in the range of 7 to 10.5 cal^{0.5}/cm^{1.5}, in the range of 7 to 9 cal^{0.5}/cm^{1.5}, or in the range of 7.5 to 9 cal^{0.5}/cm^{1.5}. The solubility parameter can be calculated, for example, with software commercially available under the trade designation MOLECULAR MODELING PRO from ChemSW, Inc. of Fairfield, Calif. using the method described by D. W. van Krevelen in the book Properties of Polymers: Their Correlation with Chemical Structure: Their Numerical Estimation and Prediction from Additive Group Contributions, 4^{th} edition, pp. 200-225, 1990, published by Elsevier in Amsterdam, The Netherlands.

Empirical methods can be used to identify potentially suitable oil displacing agents for a particular application. For example, approximately 20 to 100 microliters of a candidate oil displacing agent can be gently deposited on the surface of a substrate covered with a film of the hydrocarbon-containing material. Potentially suitable candidate oil displacing agents will typically spread out and cause the film of hydrocarbon-containing material to rupture. While not wishing to be bound by theory, potentially suitable oil displacing agents are believed to at least partially dissolve the hydrocarbon-containing material and/or to at least partially diffuse into the hydrocarbon-containing material. The droplet of suitable oil displacing agents tends to push the hydrocarbon-containing material outward from the impact area.

Although empirical methods can facilitate the relatively quick identification of potential oil displacing agents, not all compounds that pass such a test can be used successfully as oil displacing agents based on other considerations. For example, some compounds can cause film rupture but are too volatile in the curable coating compositions or not suitably miscible with the curable coating composition to be effective as oil displacing agents.

The boiling point of the oil displacement agent is at least 200° C. In some embodiments, the boiling point is at least 220° C., 240° C., 260° C., 280° C., or 300° C.

Many different classes of compounds may be suitable for the oil displacing agent. Suitable types of compounds often include, but are not limited to, glycidyl esters, mono-esters, di-esters, trialkyl phosphates, alkyl methacrylates, alkyl trialkoxysilanes, alkanes, and alcohols. The oil displacing agent is typically not a glycidyl ether.

Some oil displacing agents are glycidyl esters of Formula (IV).

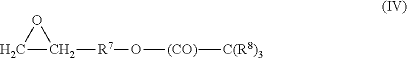

In Formula (IV), group R⁷ is an alkylene having 1 to 18 carbon atoms, 1 to 12 carbon atoms, 1 to 10 carbon atoms, 1 to 8 carbon atoms, 1 to 6 carbon atoms, or 1 to 4 carbon atoms. In some exemplary compounds of Formula (IV), group R⁷ is methylene. Each group R⁸ is independently a linear or branched alkyl have 1 to 12 carbon atoms, 1 to 10 carbon atoms, 1 to 8 carbon atoms, 1 to 6 carbon atoms, or 1 to 4 carbon atoms. One exemplary compound of Formula (IV) is commercially available under the trade designation CARDURA N10 from Hexion Specialty Chemicals in Columbus, Ohio. This oil displacing agent is a glycidyl ester of a highly branched tertiary carboxylic acid (neodecanoic acid) having 10 carbon atoms.

Some oil displacing agents are mono-esters. Suitable mono-esters can be of Formula (V).

R¹⁰—O—(OC)—R⁹ (V)

In Formula (V), the group R¹⁰ is usually a linear or branched alkyl having 1 to 20 carbon atoms, 1 to 18 carbon atoms, 1 to 12 carbon atoms, or 1 to 8 carbon atoms. Group R⁹ is an alkyl, an alkene-yl (i.e., an alkene-yl is a monovalent radical of an alkene), an aryl, or an arylalkyl. Suitable alkyl and alkene-yl groups for R⁹ often have 6 to 20 carbon atoms, 8 to 20 carbon atoms, 8 to 18 carbon atoms, or 8 to 12 carbon atoms. The alkyl and alkene-yl can be unsubstituted or substituted with a hydroxyl group, an amino group, an aryl group, or an alkylaryl group. Suitable amino group substituents are of formula —N(R¹)₂ where each R¹ is independently an hydrogen, alkyl, aryl, or alkylaryl. Suitable aryl groups for R¹, R⁹, and substituents often have 6 to 12 carbon atoms. The aryl group is often phenyl or biphenyl. Suitable alkyl groups for R¹ often have 1 to 10 carbon atoms, 1 to 6 carbon atoms, or 1 to 4 carbon atoms. Suitable arylalkyl groups for R¹, R⁹, and substituents often have an alkyl portion with 1 to 12 carbon atoms, 1 to 8 carbon atoms, or 1 to 4 carbon atoms and an aryl portion having 6 to 12 carbon atoms such as phenyl or biphenyl. Exemplary oil displacing agents of Formula (V) include, but are not limited to, alkyl oleates such as methyl oleate and alkyl benzoates such as isodecyl benzoate.

Suitable di-esters of use as oil displacing agents can be of Formula (VI).

R¹¹O(OC)—R¹²—(CO)OR¹¹ (VI)

In Formula (VI), each group R¹¹ independently is a linear or branched alkyl having at least 3 carbon atoms such as 3 to 20 carbon atoms, 3 to 18 carbon atoms, 3 to 12 carbon atoms, or 3 to 8 carbon atoms. Group R¹² is an alkane-diyl (i.e., an alkane-diyl is a divalent radical of an alkane and can be referred to as an alkylene), a heteroalkane-diyl (i.e., a heteroalkane-diyl is a divalent radical of a heteroalkane and can be referred to as a heteroalkene), or an alkene-diyl (i.e., an alkene-diyl is a divalent radical of an alkene). The alkane-diyl, heteroalkane-diyl, and alkene-diyl have at least 2 carbon atoms and often have 2 to 20 carbon atoms, 2 to 16 carbon atoms, 2 to 12 carbon atoms, or 2 to 8 carbon atoms. The heteroatom in the heteroalkane-diyl can be oxy, thio, or —NH—. The alkane-diyl, heteroalkane-diyl, and alkene-diyl can be unsubstituted or substituted with a hydroxyl group, an amino group, an aryl group, or alkylaryl group. Suitable amino group substituents are of formula —N(R¹)₂ where R¹ is an hydrogen, alkyl, aryl, or alkylaryl. Suitable aryl groups for R¹ and substituents often have 6 to 12 carbons such as a phenyl or biphenyl group. Suitable alkylaryl groups for R¹ and substituents often have an alkyl portion with 1 to 12 carbon atoms, 1 to 8 carbon atoms, or 1 to 4 carbon atoms and an aryl portion with 6 to 12 carbon atoms such as phenyl. Suitable alkyl groups for R¹ often have 1 to 12 carbon atoms, 1 to 8 carbon atoms, or 1 to 4 carbon atoms. Exemplary di-esters of Formula (VI) include, but are not limited to, dialkyl maleates such as diethylhexyl maleate and dibutyl maleate, dialkyl adipates such as diisobutyl adipate and dimethyl adipate, dialkyl succinates such as diisobutyl succinate, dialkyl glutarates such as diisobutyl glutarate, dialkyl fumarates such as dibutyl fumarate, and dialkly glutamates such as dibutyl glutamate.

Trialkyl phosphates suitable for use as oil displacing agents often have alkyl groups with 2 to 10 carbon atoms. Some exemplary trialkyl phosphates include, but are not limited to, tripropyl phosphate, triethylphosphate, and tributyl phosphate.

Alkyl methacarylates that can be used as oil displacing agents often include an alkyl group with at least 4 carbon atoms, at least 6 carbon atoms, or at least 8 carbon atoms. For example, the alkyl group can have 6 to 20 carbon atoms, 6 to 18 carbon atoms, 6 to 12 carbon atoms, or 6 to 10 carbon atoms. The alkyl in the alkyl methacrylate can be cyclic, linear, branched, or a combination thereof. Examples include, but are not limited to, isodecyl methacrylate, and 3,3,5-trimethylcyclohexyl methacrylate.

Alkyl trialkoxysilane compounds that can be used as oil displacing agents often include an alkyl group having 1 to 10 carbon atoms, 2 to 10 carbon atoms, or 2 to 6 carbon atoms. The alkyl group can be unsubstituted or substituted with an amino group such as a primary amino group or with an epoxy group. The alkoxy groups often have 1 to 6 carbon atoms, 1 to 4 carbon atoms, or 1 to 3 carbon atoms. Examples include, but are not limited to, 3-aminopropyltriethoxysilane and 2,(3,4-epoxycyclohexyl)-ethyl trimethoxysilane.

Alkanes that can be used as oil displacing agents often contain at least 12 carbon atoms. Examples include, but are not limited to, n-dodecane, n-tridecane and n-tetradecame.

Alcohols that can be used as the oil displacing agents often contain at least 10 carbon atoms, or at least 12 carbon atoms. Examples include, but are not limited to, 1-decanol, 1-undecanol and 1-dodecanol.

Table 1 includes surface tension values and solubility parameter values for some example oil displacing agents.

TABLE 1
Characteristics of Various Oil Displacing Agents

| | Surface | Solubility | Boiling |
|---|---|---|---|
| | Tension | Parameter | Point |
| Oil Displacing Agent | (dynes/cm) | (cal^{0.5}/cm^{1.5}) | (° C.) |
| 3-aminopropyltriethoxysilane | 23.5 | 9.37 | 217 |
| Methyl oleate | 29.0 | 8.19 | 351 |
| Isodecyl benzoate | 29.6 | 9.19 | 322 |
| Dimethyl adipate | 31.2 | 9.58 | 225 |
| Dibutyl maleate | 27.6 | 9.08 | 280 |
| Dibutyl fumarate | 28.7 | 9.08 | 280 |
| Diethylhexyl maleate | 25.6 | 8.60 | 418 |
| CARDURA N-10 | 28.9 | 8.84 | 251 |
| 3,3,5-Trimethylcyclohexyl | 26.7 | 8.10 | 231 |
| methacrylate | | | |
| 2,(3,4-Epoxycyclohexyl)-ethyl | 31.2 | 8.70 | 310 |
| trimethoxysilane | | | |

The curable coating compositions often contain enough oil displacing agent to form at least a monolayer on a substrate surface. Often, the curable coating compositions contain at least 0.1 weight percent of the oil displacing agent based on a total weight of the curable coating composition. The amount can be at least 0.2 weight percent, at least 0.5 weight percent, or at least 1 weight percent. The curable coating composition often includes up to 25 weight percent, up to 20 weight percent, up to 15 weight percent, or up to 10 weight percent of the oil displacing agent. If the content is too high, the oil displacing agent can act as a plasticizer and the glass transition temperature of the cured coating may be undesirably depressed and the overall performance of the cured coating may be reduced. In many embodiments, the oil displacing agent is present in an amount in the range of 0.1 to 25 weight percent, in the range of 0.5 to 20 weight percent, in the range of 1 to 20 weight percent, in the range of 1 to 10 weight percent, in the range of 2 to 10 weight percent, or in the range of 1 to 5 weight percent.

The curable coating compositions further include oil absorbing fibers. Without wishing to be bound by theory, it is believed these fibers may absorb at least some of the hydrocarbon-containing material at the surface of a substrate thus enhancing adhesion of the coatings to the substrate. As used herein, the term “fiber” refers to a natural organic fiber, a synthetic organic fiber, a natural inorganic fiber, or a synthetic fiber having an aspect ratio (length to width ratio) equal to at least 4, at least 5, at least 10, at least 20, or at least 50. The fibers can have any suitable length but often have an average length equal to at least 300 micrometers. Longer fibers tend to have a higher oil absorption capacity that shorter fibers. In some embodiment, the average length of the fibers is at least 350 micrometers, at least 400 micrometers, at least 450 micrometers, or at least 500 micrometers. The fibers typically have an average length less than 1000 micrometers or less than the thickness of the coating. If the length is greater than this, the uniformity of the coating may be reduced. Any suitable fiber diameter can be used. Example fibers have an average diameter less than 50 micrometers, less than 40 micrometers, less than 30 micrometers, less than 20 micrometers, or less than 10 micrometers.

The term “oil absorbing” means that the fibers absorb at least 30 grams of oil per 100 grams of fiber based on Procedure B of ASTM D281-95 (approved again in 2007). In some embodiments, the oil adsorption is at least 40 gram, at least 50 grams, at least 60 grams, at least 80 grams, at least 100 grams, at least 150 grams, at least 200 grams, at least 250 grams, at least 300 grams, at least 350 grams, or at least 400 grams per 100 grams of fiber. The oil absorbing characteristic can be an inherent property of the fiber or can be can be imparted by a special treatment aimed at providing this property. That is, the fibers can be hydrophobic naturally or can be treated to make them hydrophobic or to increase their hydrophobicity.

Suitable inorganic fibers that are oil absorbing include, for example, mineral fibers, glass fibers, and ceramic fibers. Suitable mineral fibers include, but are not limited to, mineral wool (e.g., rock wool and slag wool), fibrous silicates, and wollastonite. Suitable glass fibers include, but are not limited to, fiberglass (e.g., glass wool and glass filament). The inorganic fibers often include SiO₂, Al₂O₃, or a mixture thereof. The inorganic fibers can further include CaO, MgO, Na₂O, K₂O, Fe₂O₃, TiO₂, other oxides, or mixtures thereof. Some example inorganic fibers that are oil absorbing are commercially available under the trade designation COATFORCE (e.g., COATFORCE CF10 and COATFORCE CF50) from Lapinus Fibres BV in Roermond, The Netherlands. These inorganic fibers have high alumina and low silica content. Some other example inorganic fibers are commercially available under the trade designation NYAD (e.g., NYAD G) from Nyco in Willsboro, N.Y. These fibers are based on wollastonite (i.e., calcium silicate).

Some organic fibers that can be oil absorbing may be, for example, polyolefin fibers such as polyethylene fibers and polypropylene fibers. Suitable examples of organic fibers are those commercially available under the trade designation SYLOTHIX or ABROTHIX from EP Minerals in Reno, Nev., under the trade designation SHORT STUFF from MiniFIBERS, Inc. in Johnson City, Tenn., or under the trade designation INHANCE PEF from Inhance/Fluoro-Seal, Ltd. in Houston, Tex. More specifically, SYLOTHIX 51, SHORT STUFF ESS2F, and SHORT STUFF ESS5F are each fibrillated polyethylene fibers that have not been surface treated. SYLOTHIX 52, SYLOTHIX 53, and SHORT STUFF ESS50F are each fibrillated polyethylene fibers that have been surface treated. The surface treatment can increase the hydrophobicity of the fibers, improve the dispersibility of the fibers in the curable coating composition, or improve the adhesion of the fibers to the polymeric material (e.g., epoxy resin) in the coating composition.

Other organic fibers that can be oil absorbing include aramid fibers such as those commercially available under the trade designation INHANCE KF from Inhance/Fluoro-Seal, Ltd. These fibers are fibrillated and have been surface treated to make them hydrophobic or more hydrophobic.

The oil absorbing fibers can be added to the first part of the curable coating composition that includes the epoxy resin, to the second part of the curable coating composition that includes the curing agent, or to both the first part and to the second part. The amount of the oil absorbing fiber is dependent on the cleanliness of the substrate. If the substrate surface is clean or only slightly contaminated, lower levels of the oil absorbing fiber can be used. Substrates that are more contaminated need higher levels of the oil absorbing fiber. The cured and curable coating compositions typically contain up to 30 weight percent oil absorbing fibers based on a total weight of the composition (e.g., total weight of the first and second parts combined). If the loading is much higher, the composition may have an insufficient amount of the polymeric material (e.g., epoxy resin) to provide the desired corrosion resistance, chemical resistance, water resistance, or combination thereof. In some examples, the compositions contain up to 25 weight percent, up to 20 weight percent, up to 15 weight percent, or up to 10 weight percent oil absorbing fibers. The amount of oil absorbing fiber is usually at least 0.1 weight percent. At lower levels, the amount of the oil absorbing fiber may be too low to be effective. In some examples, the compositions contain at least 0.5 weight percent, at least 1 weight percent, at least 2 weight percent, or at least 5 weight percent oil absorbing fibers. Some compositions contain 0.1 to 30 weight percent, 1 to 30 weight percent, 1 to 20 weight percent, 1 to 15 weight percent, 1 to 10 weight percent, or 5 to 10 weight percent oil absorbing fibers.

In some embodiments, all of the oil absorbing fibers are inorganic fibers. In other embodiments, all of the oil absorbing fibers are inorganic fibers, non-fibrillated organic fibers, or a mixture thereof. In still other embodiments, the oil absorbing fibers are non-fibrillated organic fibers. All of these embodiments are free or substantially free of fibrillated organic fibers. As used herein the term “substantially free of” means that less than 1 weight percent, less than 0.5 weight percent, or less than 0.1 weight percent of the oil absorbing fibers are fibrillated fibers based on a total amount of oil absorbing fibers.

Although some of the oil absorbing organic fibers can be fibrillated, no greater than 50 weight percent of the total amount of oil absorbing fibers included in the coating compositions can be fibrillated. For example, if the composition includes 1 to 30 weight percent oil absorbing fibers, the amount of fibrillated organic fibers can be no greater than 0.5 to 15 weight percent based on a total weight of the composition. The fibrillated organic fibers tend to give a rough or non-uniform appearance to the cured coating composition. The ease of application of the coating compositions to a substrate surface can be inversely related to the amount of fibrillated organic fibers included in the coating composition. That is, coating compositions without fibrillated organic fibers or with low amounts of fibrillated fibers can typically be applied more easily than coating compositions with greater amounts of fibrillated organic fibers. If the amount of the fibrillated organic fibers included in the coating composition is too high, the cured coating can have an oatmeal-like or mottled appearance. That is, the coating compositions do not have a smooth and matte finish. If fibrillated organic fibers are included in the compositions, the amount is often no greater than 40 weight percent, no greater than 30 weight percent, no greater than 20 weight percent, no greater than 10 weight percent, no greater than 5 weight percent of the oil absorbing fibers included in the composition are fibrillated.

In addition to the oil absorbing fibers, other fibers that are not oil absorbing can be included in the compositions. These fibers can be inorganic fibers, organic fibers, or a mixture thereof. Examples of these other fibers include, but are not limited to, cellulose fibers and the like.

In addition to fibers, the compositions can include optional filler materials. As used herein, the term “filler” refers to particulate materials having an aspect ratio less than 4. The filler materials (i.e., fillers) can be inorganic material, organic materials, or composite materials containing both inorganic and organic materials. Some filler materials have an irregular, spherical, elliptical, or platelet shape. The fillers can have any suitable size. If smooth coatings are desired, the fillers typically have an average particle size no greater than 500 micrometers, no greater than 200 micrometers, no greater than 100 micrometers, or no greater than 50 micrometers.

The fillers can be added to the first part of the curable coating composition, to the second part of the curable coating composition, or to both the first part and the second part of the curable coating composition. Fillers are often added to promote adhesion, to improve corrosion resistance, to control the rheological properties, to reduce shrinkage during curing, to accelerate curing, to absorb contaminants, to improve heat resistance, or for a combination thereof.

Examples of suitable fillers include, but are not limited to, silica-gels, calcium silicates, calcium nitrate, calcium phosphates, calcium molybdates, calcium carbonate, calcium hydroxide, amorphous silica, fumed silica, clays such as bentonite, organo-clays, aluminium trihydrates, glass microspheres, hollow glass microspheres, polymeric microspheres, and hollow polymeric microspheres. The fillers can also be a pigment such as ferric oxide, brick dust, carbon black, titanium oxide and the like. Any of these filler can be surface modified to make them more compatible with the curable or cured coating composition.

Example fillers include a mixture of synthetic amorphous silica and calcium hydroxide that is commercially available from W.R. Grace in Columbia, Md. under the trade designation SHIELDEX (e.g., SHIELDEX AC5), a fumed silica treated with polydimethylsiloxane to prepare a hydrophobic surface that is available from Cabot GmbH in Hanau, Germany under the trade designation CAB-O-SIL (e.g., CAB-O-SIL TS 720), a hydrophobic fumed silica available from Degussa in Dusseldorf, Germany under the trade designation AEROSIL (e.g., AEROSIL VP-R-2935), glass beads class IV (250 to 300 micrometers) from CVP S.A. in France, epoxysilane-functionalized (2 wt %) aluminium trihydrate available under the trade designation APYRAL 24ES2 from Nabaltec GmbH in Schwandorf, Germany, calcium carbonate, surface treated calcium carbonate such as that available from Imerys in Rosewell, Ga. under the trade designation IMERSEAL (e.g., IMERSEAL 75), and talc such as that available from Luzenac America in Centennial, Colo. under the trade designation MISTRON (e.g., MISTRON 353).

The curable coating composition can contain any suitable amount of filler or fibers that are not oil absorbing. In many embodiments, the curable coating composition contains 0.1 to 50 weight percent non-oil absorbing filler or fiber based on a total weight of the curable or cured coating composition. If higher amounts were used, there may be an insufficient amount of the polymeric material (e.g., epoxy resin) to provide the desired chemical resistance, corrosion resistance, water resistance, or combination thereof. For example, the amount can be in the range of 0.5 to 50 weight percent, in the range of 1 to 40 weight percent, in the range of 1 to 30 weight percent, in the range of 1 to 20 weight percent, in the range of 1 to 10 weight percent, in the range of 5 to 30 weight percent, or in the range of 5 to 20 weight percent.

The coating compositions can optionally include a toughening agent. If a toughening agent is added, it is typically a liquid at room temperature or in the range of about 20° C. to about 30° C. More specifically, suitable toughening agents are flowable at these temperatures. Suitable toughening agents often have a Brookfield viscosity at room temperature that is no greater than about 300,00 centipoises, no greater than 200,000 centipoises, or no greater than 100,000 centipoises. If present, the toughening agent can be added to the first part, to the second part, or to both the first and second parts of the curable coating composition.

Suitable toughening agents tend to phase separate from the other components in the cured coating composition. Some suitable toughening agents include, but are not limited to, butadiene-nitrile rubbers (e.g., amine-terminated butadiene-nitrile rubbers (ATBN), carboxyl-terminated butadiene rubbers (CTBN), or epoxy-terminated butadiene rubbers (ETBN)), acrylic polymers and copolymers such as the elastomeric materials discussed in U.S. Pat. No. 4,524,181 (Adam et al.), amphiphilic block copolymers such as those commercially available from Dow Chemical in Midland, Mich. under the trade designation FORTEGRA 100, a triblock copolymers such as the copolymer of polystyrene, 1,4-polybutadiene, and syndiotactive poly(methyl methacrylate) (SBM) that is commercially available from Arkema, Inc. in Philadelphia, Pa. under the trade designation NANOSTRENGTH, and the like.

Other suitable toughening agents can be prepared by reacting amino-terminated materials or carboxyl-terminated materials with an epoxy resin to prepare an adduct that phase separates from the other components in the cured coating composition. Suitable amino-terminated materials that can be used to prepare such toughening agents include, but are not limited to, those commercially available under the trade designation DYNAMAR POLYETHERDIAMINE HC 1101 from 3M Corporation in Saint Paul, Minn. This is a linear polymeric material. Suitable carboxyl-terminated materials include carboxyl-terminated butadiene acrylonitrile copolymers such as those commercially available from Emerald Chemical in Alfred, Me.

Some coating compositions do not include a toughening agent. Stated differently, the coating compositions are free or substantially free of a toughening agent. As used herein with reference to the toughening agent, the term “substantially free” means that the coating compositions contain less than 0.1 weight percent or less than 0.05 weight percent toughening agents based on a total weight of the coating composition.

Other coating compositions contain up to 5 weight percent toughening agent. If larger amounts of toughening agents are used, the viscosity of the curable coating composition may increase to an extent that application of a uniform layer of the coating composition to a substrate can be difficult. If present, the toughening agent is often present in an amount no greater than 4 weight percent, no greater than 3 weight percent, no greater than 2 weight percent, or no greater than 1 weight percent. For example, the coating composition can contain 0 to 5 weight percent, 0 to 4 weight percent, 0 to 3 weight percent, 0 to 2 weight percent, or 0 to 1 weight percent toughening agent.

The curable coating composition often contains up to 80 weight percent epoxy resin, up to 60 weight percent curing agent, up to 20 weight percent oil displacing agent, and up to 30 weight percent oil absorbing fiber. Some of these curable coating compositions are free or substantially free of toughening agents. Other curable coating compositions contain up to 5 weight percent toughening agents. The weights are based on a total weight of the curable coating composition. No greater than 50 weight percent of the oil absorbing fibers are fibrillated organic fibers. In some embodiments, the oil absorbing fibers are free or substantially free of fibrillated organic fibers.

The curable coating compositions often contain at least 20 weight percent epoxy resin, at least 10 weight percent curing agent, at least 0.1 weight percent oil displacing agent, and at least 0.1 weight percent oil absorbing fibers. Some of these curable coating compositions are free or substantially free of toughening agents. Other curable coating compositions contain up to 5 weight percent toughening agents. The weights are based on a total weight of the curable coating composition. No greater than 50 weight percent of the oil absorbing fibers are fibrillated organic fibers. In some embodiments, the oil absorbing fibers are free or substantially free of fibrillated organic fibers.

Some curable coating compositions contain 20 to 80 weight percent epoxy resin, 10 to 60 weight percent curing agent, 0.1 to 20 weight percent oil displacing agent, 0.1 to 30 weight percent oil absorbing fiber, and 0 to 5 weight percent toughening agent based on a total weight of the curable coating composition. No greater than 50 weight percent of the oil absorbing fibers are fibrillated organic fibers. In some embodiments, the oil absorbing fibers are free or substantially free of fibrillated organic fibers.

Other curable coating compositions contain 30 to 70 weight percent epoxy resin, 20 to 40 weight percent curing agent, 1 to 15 weight percent oil displacing agent, 1 to 20 weight percent oil absorbing fiber, and 0 to 5 weight percent toughening agent based on a total weight of the curable coating composition. No greater than 50 weight percent of the oil absorbing fibers are fibrillated organic fibers. In some embodiments, the oil absorbing fibers are free or substantially free of fibrillated organic fibers.

Still other curable coating compositions contain 40 to 60 weight percent epoxy resin, 20 to 30 weight percent curing agent, 5 to 15 weight percent oil displacing agent, 5 to 10 weight percent oil absorbing fiber, and 0 to 5 weight percent toughening agent based on a total weight of the curable coating composition. No greater than 50 weight percent of the oil absorbing fibers are fibrillated organic fibers. In some embodiments, the oil absorbing fibers are free or substantially free of fibrillated organic fibers.

Yet other curable coating compositions contain 20 to 80 weight percent epoxy resin, 10 to 60 weight percent curing agent, 0.1 to 20 weight percent oil displacing agent, and 0.1 to 30 weight percent oil absorbing fiber. The compositions are free or substantially free of fibrillated organic fibers and are free or substantially free of toughening agents.

Other optional components can be included in the curable coating compositions. For example, various accelerators such as various metal salts can be added. Useful metal salts include, for example, calcium (Ca⁺²) salts, magnesium (Mg⁺²) salts, bismuth (Bi⁺³) salts, cerium (Ce⁺³) salts, iron salts (Fe⁺³), lead (Pb⁺¹) salts, copper (Cu⁺²) salts, cobalt (Co⁺²) salts, lanthanum (La⁺³) salts, lithium (Li⁺¹) salts, indium (In⁺³) salts, thallium (Th⁺⁴) salts, beryllium (Be⁺²) salts, barium (Ba⁺²) salts, strontium (Sr⁺²) salts, and zinc (Zn⁺²) salts. In many embodiments, the accelerators are selected to be calcium salts, magnesium salts or lanthanum salts. Suitable anions of the metal salts include, but are not limited to, NO₃⁻, CF₃SO₃⁻, ClO₄⁻, BF₄⁻, CH₃C₆H₄SO₃⁻, and SbF₆⁻.

In some embodiments, still other optional components can be included in the curable coating compositions such as defoamers, thixotropes, and adhesion promoters. Example defoamers include, but are not limited, to those commercially available from BYK USA in Wallingford, Conn. under the trade designation BYK-A-500. Example thixotropes include, but are not limited to, non-reactive polyamide thixotropes such as those commercially available from King Industries in Norwalk, Conn. under the trade designation DISPARLON (e.g., DISPARLON 6500). Example adhesion promoters include, but are not limited to, various silane compounds. Some silane compounds that are suitable for adhesion promoters have amino groups or glycidyl groups that can react with one or more components in the curable coating composition. One such silane compound is a glycidoxypropyltrimethoxysilane that is commercially available under the trade designation SILANE Z6040 from Dow Corning, Midland, Mich. Other exemplary adhesive promoters include various chelating agents such as those described in U.S. Pat. No. 6,632,872 (Pellerite et al.) and various chelate-modified epoxy resins such as those available from Adeka Corporation in Tokyo, Japan under the trade designation EP-49-10N and EP-49-20. These materials contain oxirane groups but are typically added in low amounts to the curable coating composition.

In some embodiments, plasticizers such as phthalates, nonyl phenol, and benzyl alcohol are not added. That is, the curable coating composition is free or substantially free of these materials. As used herein with reference to plasticizers and phthalates, the term “substantially free” means that the curable coating composition contains no more than 0.1 weight percent or no more then 0.05 weight percent of these components based on a total weight of the curable coating composition. These plasticizers have know environmental or health concerns.

The curable coating compositions are typically free or substantially free of a liquid reactive modifier. As used herein with reference to a reactive modifier, the term “substantially free” means that the curable coating composition contains no more than 0.1 weight percent or no more than 0.05 weight percent of this material based on a total weight of the curable coating composition. Reactive liquid modifiers are often acetoacetoxy-functionalized materials that tend to react quite rapidly with the curing agent to form a gel-like composition that can be difficult to apply to a substrate as a coating.

Organic solvents can be included in curable coating composition. As used herein, the term “organic solvent” refers to typical solvents used in coating compositions with a boiling point less than 200° C. Solvents can be added to lower the viscosity of either the first part or the second part of the curable coating composition or can be added with one of the various components included in the curable coating composition. If added to the curable coating compositions, the organic solvent content is typically minimized and is often less than 15 weight percent based on a total weight of the curable coating composition. The solvent is often less than 12 weight percent, less than 10 weight percent, less than 8 weight percent, less than 6 weight percent, less than 4 weight percent, less than 2 weight percent, less than 1 weight percent, or less than 0.5 weight percent based on the total weight of the curable coating composition. Suitable organic solvents include those that are soluble in the curable coating composition and that can be removed during or after curing to form the cured coating composition. Example organic solvents include, but are not limited to, toluene, acetone, various alcohols, and xylene.

Some coating compositions are free or substantially free of an organic solvent. As used herein in reference to the organic solvent, the term “substantially free” means that the coating composition contains no more then 0.1 weight percent or no more than 0.05 weight percent organic solvent.

The curable coating composition typically is in the form of a first part and a second part. The first part typically includes the epoxy resins plus other components that do not react with the epoxy resin. The second part typically includes the curing agent plus any other components that do not typically react with the curing agent. The oil displacing agent, the oil absorbing fibers, and any optional toughening agent can be added to the first part, the second part, or both the first and second parts. The components in each part are typically selected to minimize reactivity within that part.

Alternatively, the curable coating composition can include additional parts such as a third part that can contain additional components or that can further separate the components of the curable coating composition. For example, the epoxy resin can be in a first part, the curing agent can be in a second part, and any other components can be in the first part, second part, third part, or a combination thereof.

The various parts of the curable coating composition are mixed together to form the cured coating composition. These parts are typically mixed together immediately prior to use of the curable coating composition. The amount of each part included in the mixture can be selected to provide the desired molar ratio of oxirane groups to amine hydrogen atoms. The particular components are also selected so that the curable coating composition does not form a gel prior to application onto a substrate.

The curable coating composition can be cured at room temperature, can be cured at room temperature and then at an elevated temperature (e.g., greater than 100° C., greater than 120° C., or greater than 150° C.), or can be cured at an elevated temperature. In some embodiments, the curable coating composition can be cured at room temperature for at least 3 hours, at least 6 hours, at least 12 hours, at least 18 hours, at least 24 hours, at least 48 hours, or at least 72 hours. In other embodiments, the curable coating composition can be cured at room temperature for any suitable length of time and then further cured at an elevated temperature such as, for example, 180° C. for a time up to 10 minutes, up to 20 minutes, up to 30 minutes, up to 60 minutes, up to 120 minutes, or even longer than 120 minutes.

The coating compositions can be applied to a variety of substrate surfaces. Suitable substrates include polymeric materials, glasses, ceramic materials, composite materials, and metal-containing surfaces. The coatings are particularly useful on metal-containing substrates such as metals, metal oxides, and various alloys. The coatings can provide chemical resistance, corrosion resistance, water resistance, or a combination thereof.

The coatings can be used on clean substrates or on substrates contaminated with various hydrocarbon-containing materials. The surface of the substrates may be cleaned prior to application of the curable coating composition. However, the curable coating compositions are also useful in applications when applied to substrates having hydrocarbon-containing material on the surface. In particular, the curable coating compositions may be applied to steel surfaces contaminated with various oils and lubricants such as, for example, mill oil, cutting fluid, and draw oil.

Any suitable application method can be used to apply the curable coating composition to a surface of a substrate. Suitable application methods include, for example, brushing, rolling, spraying, dipping, and the like.

The cured coating compositions can typically adhere to clean metal-containing surfaces and to metal-containing surfaces contaminated with hydrocarbon-containing materials such as various oils and lubricants. The impact performance of the cured coatings applied to surfaces contaminated with hydrocarbon-containing materials is typically comparable to that of cured coatings applied to clean surfaces. This is surprising and demonstrates that there is usually good adhesion at the interface between the substrate and the cured coating. If the cured coatings are scored, the coating typically does not fail at that interface between the substrate and the coating. This further demonstrates that there is usually good adhesion at the interface between the substrate and the cured coating.

Various items are provided that include a curable coating composition, a cured coating composition, an article containing a cured coating composition, and a method of coating.

Item 1 is a curable coating composition that has a first part and a second part. The curable coating composition comprises a) an epoxy resin in the first part of the curable coating composition, b) a curing agent in the second part of the curable coating composition, c) an oil displacing agent, d) an oil absorbing fiber, and e) an optional toughening agent. The curing agent has at least two amino groups of formula —NR¹H where R¹ is hydrogen, alkyl, aryl, or aralkyl. The oil displacing agent is soluble in the curable coating composition, has a surface tension in a range of 15 to 32 dynes/cm, and has a boiling point of at least 200° C. The oil absorbing fiber contains 0 to 50 weight percent fibrillated organic fiber based on a total weight of oil absorbing fiber in the curable coating composition. The toughening agent, if present, is a liquid at temperatures in a range of 20° C. to 30° C. and is present in a concentration range of 0 to 5 weight percent based on a total weight of the curable coating composition.

Item 2 is the curable coating composition of item 1, wherein the curable coating composition comprises 20 to 80 weight percent epoxy resin, 10 to 60 weight percent curing agent, 0.1 to 20 weight percent oil displacing agent, 0.1 to 30 weight percent oil absorbing fibers, and 0 to 5 weight percent toughening agent.

Item 3 is the curable coating composition of item 1, wherein the curable coating composition comprises 30 to 70 weight percent epoxy resin, 20 to 40 weight percent curing agent, 1 to 15 weight percent oil displacing agent, 1 to 20 weight percent oil absorbing fiber, and 0 to 5 weight percent toughening agent based on a total weight of the curable coating composition.

Item 4 is the curable coating composition of item 1, wherein the curable coating composition comprises 40 to 60 weight percent epoxy resin, 20 to 30 weight percent curing agent, 5 to 15 weight percent oil displacing agent, 5 to 10 weight percent oil absorbing fiber, and 0 to 5 weight percent toughening agent based on a total weight of the curable coating composition.

Item 5 is the curable coating composition of any one of items 1 to 4, wherein the oil absorbing fiber is an inorganic fiber.

Item 6 is the curable coating composition any one of items 1 to 5, wherein the oil absorbing fiber is free or substantially free of fibrillated organic fiber.

Item 7 is the curable coating composition of any one of items 1 to 6, wherein the composition is free or substantially free of the toughening agent.

Item 8 is the curable coating composition of any one of items 1 to 7, wherein the epoxy resin comprises an epoxy phenol novolac.

Item 9 is the curable coating composition of any one of items 1 to 8, wherein the epoxy resin has reactive glycidyl groups and a molar ratio of glycyidyl groups in the epoxy resin to amino groups in the curing agent is in a range of 1.2:1 to 1:1.2.

Item 10 is the curable coating composition of any one of items 1 to 9, wherein the composition is free of essentially free of a reactive liquid modifier having acetoacetoxy groups.

Item 11 is the curable coating composition of item 1, wherein the curable coating composition comprises 20 to 80 weight percent epoxy resin, 10 to 60 weight percent curing agent, 0.1 to 20 weight percent oil displacing agent, and 0.1 to 30 weight percent oil absorbing fiber. The curable coating compositions are free or substantially free of fibrillated organic fibers and are free or substantially free of toughening agents.

Item 12 is the curable coating composition of any one of items 1 to 11, wherein the oil absorbing fiber has an average length that is at least 300 micrometers.

Item 13 is the curable coating composition of any one of items 1 to 12, wherein the composition is free or substantially free of an organic solvent having a boiling point less than 200° C. Item 14 is the curable coating composition of any one of items 1 to 13, wherein the oil absorbing fibers have an oil absorbing capacity of at least 60 grams per 100 grams of fiber based on ASTM D281-95.

Item 15 is a cured coating composition comprising a reaction product of a curable coating composition. The curable coating composition comprises a) an epoxy resin, b) a curing agent, c) an oil displacing agent, d) an oil absorbing fiber, and e) an optional toughening agent. The curing agent has at least two amino groups of formula —NR¹H where R¹ is hydrogen, alkyl, aryl, or aralkyl. The oil displacing agent is soluble in the curable coating composition, has a surface tension in a range of 15 to 32 dynes/cm, and has a boiling point of at least 200° C. The oil absorbing fiber contains 0 to 50 weight percent fibrillated organic fiber based on a total weight of oil absorbing fiber in the curable coating composition. The toughening agent, if present, is a liquid at temperatures in a range of 20° C. to 30° C. and is present in a concentration range of 0 to 5 weight percent based on a total weight of the curable coating composition.

Item 16 is the cured coating composition of item 15, wherein the curable coating composition comprises 20 to 80 weight percent epoxy resin, 10 to 60 weight percent curing agent, 0.1 to 20 weight percent oil displacing agent, 0.1 to 30 weight percent oil absorbing fibers, and 0 to 5 weight percent toughening agent.

Item 17 is the cured coating composition of item 15, wherein the curable coating composition comprises 30 to 70 weight percent epoxy resin, 20 to 40 weight percent curing agent, 1 to 15 weight percent oil displacing agent, 1 to 20 weight percent oil absorbing fiber, and 0 to 5 weight percent toughening agent based on a total weight of the curable coating composition.

Item 18 is the cured coating composition of item 15, wherein the curable coating composition comprises 40 to 60 weight percent epoxy resin, 20 to 30 weight percent curing agent, 5 to 15 weight percent oil displacing agent, 5 to 10 weight percent oil absorbing fiber, and 0 to 5 weight percent toughening agent based on a total weight of the curable coating composition.

Item 19 is the cured coating composition of any one of items 15 to 18, wherein the oil absorbing fiber is an inorganic fiber.

Item 20 is the cured coating composition any one of items 15 to 19, wherein the oil absorbing fiber is free or substantially free of fibrillated organic fiber.

Item 21 is the cured coating composition of any one of items 15 to 20, wherein the composition is free or substantially free of the toughening agent.

Item 22 is the cured coating composition of any one of items 15 to 21, wherein the epoxy resin comprises an epoxy phenol novolac.

Item 23 is the cured coating composition of any one of items 15 to 22, wherein the epoxy resin has reactive glycidyl groups and a molar ratio of glycyidyl groups in the epoxy resin to amino groups in the curing agent is in a range of 1.2:1 to 1:1.2.

Item 24 is the cured coating composition of any one of items 15 to 23, wherein the composition is free of essentially free of a reactive liquid modifier having acetoacetoxy groups.

Item 25 is the cured coating composition of item 15, wherein the curable coating composition comprises 20 to 80 weight percent epoxy resin, 10 to 60 weight percent curing agent, 0.1 to 20 weight percent oil displacing agent, and 0.1 to 30 weight percent oil absorbing fiber. The curable coating compositions are free or substantially free of fibrillated organic fibers and are free or substantially free of toughening agents.

Item 26 is the cured coating composition of any one of items 15 to 25, wherein the oil absorbing fiber has an average length that is at least 300 micrometers.

Item 27 is the cured coating composition of any one of items 15 to 26, wherein the composition is free or substantially free of an organic solvent having a boiling point less than 200° C.

Item 28 is the cured coating composition of any one of items 15 to 27, wherein the oil absorbing fibers have an oil absorbing capacity of at least 60 grams per 100 grams of fiber based on ASTM D281-95.

Item 29 is an article comprising a substrate and a cured coating positioned adjacent to the substrate. The cured coating composition comprises a reaction product of a curable coating composition. The curable coating composition comprises a) an epoxy resin, b) a curing agent, c) an oil displacing agent, d) an oil absorbing fiber, and e) an optional toughening agent. The curing agent has at least two amino groups of formula —NR¹H where R¹ is hydrogen, alkyl, aryl, or aralkyl. The oil displacing agent is soluble in the curable coating composition, has a surface tension in a range of 15 to 32 dynes/cm, and has a boiling point of at least 200° C. The oil absorbing fiber contains 0 to 50 weight percent fibrillated organic fiber based on a total weight of oil absorbing fiber in the curable coating composition. The toughening agent, if present, is a liquid at temperatures in a range of 20° C. to 30° C. and is present in a concentration range of 0 to 5 weight percent based on a total weight of the curable coating composition.

Item 30 is the article of item 29, wherein the curable coating composition comprises 20 to 80 weight percent epoxy resin, 10 to 60 weight percent curing agent, 0.1 to 20 weight percent oil displacing agent, 0.1 to 30 weight percent oil absorbing fibers, and 0 to 5 weight percent toughening agent.

Item 31 is the article of item 29, wherein the curable coating composition comprises 30 to 70 weight percent epoxy resin, 20 to 40 weight percent curing agent, 1 to 15 weight percent oil displacing agent, 1 to 20 weight percent oil absorbing fiber, and 0 to 5 weight percent toughening agent based on a total weight of the curable coating composition.

Item 32 is the article of item 29, wherein the curable coating composition comprises 40 to 60 weight percent epoxy resin, 20 to 30 weight percent curing agent, 5 to 15 weight percent oil displacing agent, 5 to 10 weight percent oil absorbing fiber, and 0 to 5 weight percent toughening agent based on a total weight of the curable coating composition.

Item 33 is the article of any one of items 29 to 32, wherein the oil absorbing fiber is an inorganic fiber.

Item 34 is the article of any one of items 29 to 33, wherein the oil absorbing fiber is free or substantially free of fibrillated organic fiber.

Item 35 is the article of any one of items 29 to 34, wherein the composition is free or substantially free of the toughening agent.

Item 36 is the article of any one of items 29 to 35, wherein the epoxy resin comprises an epoxy phenol novolac.

Item 37 is the article of any one of items 29 to 36, wherein the epoxy resin has reactive glycidyl groups and a molar ratio of glycyidyl groups in the epoxy resin to amino groups in the curing agent is in a range of 1.2:1 to 1:1.2.

Item 38 is the article of any one of items 29 to 37, wherein the composition is free of essentially free of a reactive liquid modifier having acetoacetoxy groups.

Item 39 is the article of item 29, wherein the curable coating composition comprises 20 to 80 weight percent epoxy resin, 10 to 60 weight percent curing agent, 0.1 to 20 weight percent oil displacing agent, and 0.1 to 30 weight percent oil absorbing fiber. The curable coating compositions are free or substantially free of fibrillated organic fibers and are free or substantially free of toughening agents.

Item 40 is the article of any one of items 29 to 39, wherein the oil absorbing fiber has an average length that is at least 300 micrometers.

Item 41 is the article of any one of items 29 to 40, wherein the composition is free or substantially free of an organic solvent having a boiling point less than 200° C.

Item 42 is the article of any one of items 29 to 41, wherein the oil absorbing fibers have an oil absorbing capacity of at least 60 grams per 100 grams of fiber based on ASTM D281-95.

Item 43 is a method of coating. The method comprises providing a substrate and applying a curable coating composition adjacent to the substrate. The curable coating composition contains a) an epoxy resin, b) a curing agent, c) an oil displacing agent, d) an oil absorbing fiber, and e) an optional toughening agent. The curing agent has at least two amino groups of formula —NR¹H where R¹ is hydrogen, alkyl, aryl, or aralkyl. The oil displacing agent is soluble in the curable coating composition, has a surface tension in a range of 15 to 32 dynes/cm, and has a boiling point of at least 200° C. The oil absorbing fiber contains 0 to 50 weight percent fibrillated organic fiber based on a total weight of oil absorbing fiber in the curable coating composition. The toughening agent, if present, is a liquid at temperatures in a range of 20° C. to 30° C. and is present in a concentration range of 0 to 5 weight percent based on a total weight of the curable coating composition. The method further includes curing the curable coating composition to provide a cured coating composition adjacent to the substrate.

Item 44 is the method of item 43, wherein the substrate is contaminated with a hydrocarbon-containing material.

Item 45 is the method of item 43 or 44, wherein the curable coating composition comprises 20 to 80 weight percent epoxy resin, 10 to 60 weight percent curing agent, 0.1 to 20 weight percent oil displacing agent, 0.1 to 30 weight percent oil absorbing fibers, and 0 to 5 weight percent toughening agent.

Item 46 is the method of item 43 or 44, wherein the curable coating composition comprises 30 to 70 weight percent epoxy resin, 20 to 40 weight percent curing agent, 1 to 15 weight percent oil displacing agent, 1 to 20 weight percent oil absorbing fiber, and 0 to 5 weight percent toughening agent based on a total weight of the curable coating composition.

Item 47 is the method of item 43 or 44, wherein the curable coating composition comprises 40 to 60 weight percent epoxy resin, 20 to 30 weight percent curing agent, 5 to 15 weight percent oil displacing agent, 5 to 10 weight percent oil absorbing fiber, and 0 to 5 weight percent toughening agent based on a total weight of the curable coating composition.

Item 48 is the method of any one of items 43 to 47, wherein the oil absorbing fiber is an inorganic fiber.

Item 49 is the method of any one of items 43 to 48, wherein the oil absorbing fiber is free or substantially free of fibrillated organic fiber.

Item 50 is the method of any one of items 43 to 49, wherein the composition is free or substantially free of the toughening agent.

Item 51 is the method of any one of items 43 to 50, wherein the epoxy resin comprises an epoxy phenol novolac.

Item 52 is the method of any one of items 43 to 51, wherein the epoxy resin has reactive glycidyl groups and a molar ratio of glycyidyl groups in the epoxy resin to amino groups in the curing agent is in a range of 1.2:1 to 1:1.2.

Item 53 is the method of any one of items 43 to 52, wherein the composition is free of essentially free of a reactive liquid modifier having acetoacetoxy groups.

Item 54 is the method of item 43, wherein the curable coating composition comprises 20 to 80 weight percent epoxy resin, 10 to 60 weight percent curing agent, 0.1 to 20 weight percent oil displacing agent, and 0.1 to 30 weight percent oil absorbing fiber. The curable coating compositions are free or substantially free of fibrillated organic fibers and are free or substantially free of toughening agents.

Item 55 is the method of any one of items 43 to 54, wherein the oil absorbing fiber has an average length that is at least 300 micrometers.

Item 56 is the method of any one of items 43 to 55, wherein the composition is free or substantially free of an organic solvent having a boiling point less than 200° C.

Item 57 is the method of any one of items 43 to 56, wherein the oil absorbing fibers have an oil absorbing capacity of at least 60 grams per 100 grams of fiber based on ASTM D281-95.

### EXAMPLES

Solvents and other reagents used were obtained from Aldrich Chemical Company, Milwaukee, Wis. unless otherwise noted.

TABLE 2
Glossary of Materials

| Material | Description |
|---|---|
| ADEKA EP-49-10-N | Trade designation for a chelate modified epoxy resin obtained from CBC |
| | America in Commack, NY. |
| AEROSHELL | Trade designation for a 5 centistoke synthetic lubricating oil for gas |
| TURBINE OIL 500 | turbine engines obtained from Shell Lubricants in Houston, TX. |
| ANCAMINE 2609 | Trade designation for an amine curative based off of meta-xylenediamine |
| | that is commercially available from Air Products in Allentown, PA. |
| ANCAMINE K54 | Trade designation for 2,4,6-tris(dimethylaminomethyl phenol) that is |
| | commercially available from Air Products in Allentown, PA. This |
| | material was used as a secondary curative. |
| ARALDITE GY289 | Trade designation for a low viscosity epoxy phenol novolac resin that is |
| | commercially available from Huntsman Advanced Materials in The |
| | Woodlands, TX. |
| BENZOFLEX 131 | Trade designation for a technical grade isodecyl benzoate provided by |
| | Genovique Specialties in Rosemount, IL. |
| BYK A-500 | Trade designation for a defoamer commercially available from BYK USA, |
| | Wallingford, CT. |
| CAB-O-SIL TS720 | Trade designation for fumed silica that has been surface modified with |
| | polydimethylsiloxane. This thixotropic filler material was obtained from |
| | Cabot Corporation in Boston, MA. |
| CARDURA N10 | Trade designation of a glycidyl ester of versatic acid that was obtained |
| | from Hexion Specialty Chemicals, Houston, TX. The material has an |
| | approximate epoxy equivalent weight of 240 to 256 grams/equivalent and |
| | was used as an oil displacing agent. |
| SYMBOL 2190 TEP | Trade designation of a circulating system oil for marine gear turbine sets |
| | that was obtained from Chevron in San Ramon, CA. |
| COATFORCE CF50 | Trade designation of an engineered mineral fiber with an average fiber |
| | length of 500 μm. According to the manufacturer, these fibers have an oil |
| | adsorption of 65 grams oil per 100 grams fiber based on ASTM D281-95. |
| | The mineral fiber was obtained from Lapinus Fibres BV, Roermond, The |
| | Netherlands. |
| DISPARLON 6500 | Trade designation of a non-reactive polyamide thixotrope that is |
| | commercially available from King Industries in Norwalk, CT. |
| EPALLOY 5001 | Trade designation of an epoxy resin based off of hydrogenated bisphenol |
| | A that is commercially available from CVC Thermoset Specialties in |
| | Moorestown, NJ. |
| EPON 828 | Trade designation of a diglycidyl ether of bisphenol A having an |
| | approximate epoxy equivalent weight of 187.5 grams/equivalent. This |
| | epoxy resin was obtained from Hexion Specialty Chemicals in Houston, |
| | TX. |
| EPONEX 1510 | Trade designation of a hydrogenated diglycidyl ether of bisphenol A. This |
| | epoxy resin was obtained from Hexion Specialty Chemicals in Houston, |
| | TX. |
| IMERSEAL 75 | Trade designation for ground, surface treated calcium carbonate filler with |
| | a mean particle size of 1.3 μm available from Imerys in Roswell, GA. |
| JEFFAMINE D400 | Trade designation for a polyether diamine with an amine hydrogen |
| | equivalent weight of 100 grams/equivalent available from Huntsman |
| | Corporation (The Woodlands, Texas). This was used as a curing agent. |
| MISTRON 353 | Trade designation for platy, high purity talc that was obtained from |
| | Luzenac America in Centennial, CO. |
| DW 1765 | Trade designation for Modifier DW 1765, a paste based on a liquid epoxy |
| | resin designed to reduce amine blushing. This material was obtained from |
| | Huntsman Advanced Materials, The Woodlands, TX. |
| Meta-xylene diamine | An amine curative that was obtained from Acros Organics USA in Morris |
| | Plains, NJ. |
| NYAD G | Trade designation for wollastonite obtained from NYCO in Willsboro, |
| | NY. These fibers have an average length of 40 micrometers. According |
| | to the manufacturer, these fibers have an oil adsorption of 45 grams oil per |
| | 100 grams of fiber based on ASTM D281-95. |
| Polyamidoamine A | An amine-terminated polyamide prepared as described in Example 2 of |
| | U.S. Pat. No. 5,629,380 (Baldwin et al.). This material was added as a |
| | curing agent. |
| Poly[(phenyl glycidyl | Technical grade was used with a number average molecular weight equal |
| ether)-co-formaldehyde] | to about 570 grams/mole. |
| SYLOTHIX 51 | Trade designation polyethylene fibers with an average length equal to |
| | approximately 400 micrometer that were obtained from EP Minerals in |
| | Reno, NV. These fibers have an oil adsorption of 398 grams per 100 |
| | grams of fiber (average of 3 samples tested using Procedure B of ASTM |
| | D281-95). |
| SYLOTHIX 52 | Trade designation of a mixture of polyethylene fibers having an average |
| | length equal to approximately 400 micrometer and synthetic amorphous |
| | silicic acid. This mixture was obtained from EP Minerals in Reno, NV. |
| | These fibers have an oil adsorption of 189 grams per 100 grams of fiber |
| | (average of 3 samples tested using Procedure B of ASTM D281-95). |
| Trimethylolpropane | Technical grade was used. |
| glycidyl ether | |
| KTL N16 | Trade designation for a deep-draw oil obtained from Zeller-Gmelin GmbH |
| | & Co. KG in Eislingen, Germany. |

### Test Methods

### Steel Surface Preparation

Prior to coating each cold rolled steel panel was extensively washed in methyl ethyl ketone and wiped with a clean paper towel in order to remove all residual cutting oils. The cleaned steel panels were then exposed to a steel grit blasting process according to No. 2/SSPC—SP 10, Near-White Metal Blast Cleaning (2007), a publication of the National Association of Corrosion Engineers. The grit blaster utilized was a TRINCO 800PT, which is commercially available from Trinity Tool Co. in Frasier, Mich.

### Oiling of Steel Panels

Oiled steel panels (specimens used as received or grit blasted as described in the previous section) were prepared by applying a specified volume of oil to provide a coating of 3 grams per square meter for the area to be coated using density data obtained from the Material Safety Data Sheet supplied by the supplier of the oil. A clean fingertip of a nitrile glove was used to spread the oil uniformly over the surface. Once the surface was covered, the oiled steel panels were stored at room temperature for 24 hours prior to use.

### Generation of Lap Shear Bonds

Lap shear specimens were made using cold rolled steel test specimens measuring 4 inches by 1 inch by 0.125 inches (101.6 mm by 25.4 mm by 3.17 mm) that were oiled using the above protocol describing the oiling of steel panels. These steel test specimens were grit blasted, prior to being oiled, as described above. A strip of approximately 1.0 inch (25.3 mm) wide and 0.010 inch (0.25 mm) thick of curable coating composition was applied to one edge of each of the two oiled lap shear specimens using a scraper. Two oiled lap shear specimens were bonded together and clamped using a 1 inch binder clip to apply pressure to provide for spreading of the curable coating composition. At least three bonds were made for each condition being testing. After the curable coating composition had been allowed to cure for at least 7 days at room temperature, the bonds were tested to failure at room temperature on a Sintech Tensile Testing machine (MTS, Eden Prairie, Minn.) using a crosshead displacement rate of 0.1 inch (2.5 mm) per minute. The failure load was recorded. The lap width was measured with a vernier caliper. The quoted lap shear strengths were calculated as failure load divided by measured bond area. The average and standard deviation were calculated from the results of at least three tests unless otherwise noted.

### Generation of Impact Specimens

Impact test specimens were made using cold rolled steel test specimens having dimension of 4 inches by 4 inches by 0.25 inches (101.6 mm by 101.6 mm by 6.4 mm) These steel test specimens were grit blasted and oiled as described above. A 40 mil (1016 micron) thick curable coating composition was applied to each specimen. The specimen was cured open faced at room temperature for a minimum of 7 days.

The specimen were placed in a Gardner Impact Tester and tested according to ASTM G14-04. All impact tests were done at 68° F. (20° C.).

### Generation of Flexibility Test Specimens

Flexibility test specimens were made using cold rolled steel test specimens (Type “S” Steel, with dimensions of 12 inches by 1 inches by 0.032 inches (304.8 mm by 25.4 mm by 0.81 mm) and with square corners, 1010 CRS from Q-Lab Corporation in Cleveland, Ohio). These steel test specimens were grit blasted and oiled as described above in the previous sections. A strip of approximately 1 inch by 9 inch by 10 mil (1 mil is equal to 0.001 inches) (25.4 mm by 228.6 mm by 0.25 mm) of curable coating composition was applied to each oiled flexibility test specimen. The specimen was cured open faced at room temperature for 7 days.

The cured specimen was wrapped around a cylinder of known diameter to shape the specimen to an arc corresponding to the same dimensions of the cylinder. The failure mode (if any) was noted.

### Generation of Test Specimens for Scoring

Test specimens for scoring were made using cold rolled steel test specimens with square corners (Type “S” Steel, 3.875 inches by 15.75 inches by 0.032 inches (98.4 mm by 400 mm by 0.81 mm) The steel test specimens are commercially available under the trade designation 1010 CRS from Q-Lab Corporation in Cleveland, Ohio. These specimens were oiled as described above. The curable coating composition was applied to the substrate using drawbar to apply a 3.875 inch by 6 inch by 0.01 inch (98.4 mm by 152.4 mm by 0.25 mm) coating. The coating was allowed to cure for 24 hours at ambient temperatures. Then, an optional second coating was applied on top of the first coating using the same procedure. This second coating was allowed to cure for 24 hours at ambient temperatures.

The cured coatings were scored by hand with a razor blade (#9 steel razor blade from The Stanley Works in New Britain, Conn.), marking an “X” with each line of the X being three inches long. The failure mode (if any) was noted.

### Preparation of Curing Agent Mixtures CA1-CA5

Amine curative mixtures CA1 to CA5 were prepared as shown in Table 2. The numbers in the table refer to the grams of each component in the formulation. The components of each formulation were charged to a DAC mixer MAX 200 cup (FlackTek, Inc. in Landrum, S.C.). Each formulation was mixed for 30 seconds at 1000 RPM and 20 seconds at 2700 RPM in a DAC Mixer 400 FVZ (FlackTek, Inc. in Landrum, S.C.). The amine curatives mixtures were stored at room temperature until used.

TABLE 3
Amine Curative Formulations

| | CA1 | CA2 | CA3 | CA4 | CA5 |
|---|---|---|---|---|---|
| JEFFAMINE D400 | 25 | 25 | 30 | 30 | 19.7 |
| M-xylenediamine | 10 | 10 | 10 | | |
| ANCAMINE 2609 | | | | 45 | 40 |
| ANCAMINE K54 | 5 | 5 | 5 | | |
| Polyamidoamine A | 20 | 20 | 25 | 25 | 15.1 |
| BENZOFLEX 131 | 20 | 20 | 30 | | |
| NYAD G | 15 | 15 | | | |
| SYLOTHIX 52 | 5 | | | | |
| SYLOTHIX 51 | | 5 | | | |
| BYK A-500 | | | | | 1.02 |
| DISPARLON 6500 | | | | | 1.1 |
| COATFORCE CF50 | | | | | 8 |
| MISTRON 353 | | | | | 13 |

### Preparation of Epoxy Resin Mixture ER1 to ER9

Epoxy resin mixtures ER1 to ER9 were prepared as shown in Table 4. The numbers in the table refer to the grams of each component in the formulation. The components of each mixture were charged to a DAC mixer MAX 200 cup. Each formulation was mixed for 30 seconds at 1000 RPM and 20 seconds at 2700 RPM in a DAC Mixer 400 FVZ. Poly[(phenyl glycidyl ether)-co-formaldehyde] and ADEKA EP-49-10-N were preheated to 60° C. prior to use. The epoxy resin mixtures were stored at room temperature until used.

TABLE 4
Epoxy Resin Formulations

| | ER1 | ER2 | ER3 | ER4 | ER5 | ER6 | ER7 | ER8 | ER9 |
|---|---|---|---|---|---|---|---|---|---|
| Poly[(phenyl glycidyl ether)- | 30 | 30 | 30 | 30 | 30 | | | | |
| co-formaldehyde] | | | | | | | | | |
| Trimethylolpropane | | | | 15 | | | | | |
| glycidyl ether | | | | | | | | | |
| CARDURA N10 | 15 | 15 | 15 | | 15 | 15 | 15 | 6.2 | 15 |
| ADEKA EP-49-10-N | 30 | 30 | 30 | 30 | 30 | 25 | 25 | | 25 |
| ARALDITE GY289 | | | | | | 30 | | | 30 |
| EPALLOY 5001 | | | | | | | 30 | | |
| EPON 828 | | | | | | | | 50 | |
| EPONEX 1510 | | | | | | | | 10 | |
| SYLOTHIX 52 | 5 | | | | | | | | |
| SYLOTHIX 51 | | 5 | | | | | | | |
| COATFORCE CF50 | | | 5 | 8 | 8 | 8 | 8 | 8 | 8 |
| NYAD G | 20 | | | | | | | | |
| IMERSEAL 75 | | 20 | 19 | 16 | 16 | 19 | 19 | | 18.5 |
| BYK A-500 | | | | | | | | 0.85 | |
| DISPARLON 6500 | | | | | | | | 0.45 | |
| DW 1765 | | | | | | | | | 0.5 |
| MISTRON 353 | | | | | | | | 20.6 | |
| CAB-O-SIL TS720 | | | 1 | 1 | 1 | 3 | 3 | | 3 |

### Examples 1 to 18

An amine curative mixture and an epoxy resin mixture were combined to form curable coating compositions Examples 1 to 18 as shown in Table 5. The amine curative and epoxy resin mixtures for each example were charged to a DAC mixer MAX 100 cup (FlackTek, Inc. in Landrum, S.C.). Each example was mixed for 30 seconds at 1000 RPM and 20 seconds at 2700 RPM in a DAC Mixer 400 FVZ (FlackTek, Inc., Landrum, S.C.). Each example was immediately applied to a steel substrate. Some of the steel substrates with covered with an oil as indicated in Table 5.

TABLE 5
Curable coating compositions

| | Curing | Epoxy | |
|---|---|---|---|
| | Agent | Resin | |
| | Mixture | Mixture | |
| Example | (grams) | (grams) | Oil on Steel |
| Example 1 | CA1 (20) | ER1 (36.1) | None |
| Example 2 | CA1 (20) | ER1 (36.1) | KTL N16 |
| Example 3 | CA2 (20) | ER2 (36.1) | None |
| Example 4 | CA2 (20) | ER2 (36.1) | KTL N16 |
| Example 5 | CA2 (20) | ER3 (36.1) | None |
| Example 6 | CA2 (20) | ER3 (36.1) | KTL N16 |
| Example 7 | CA3 (20) | ER4 (32.25) | None |
| Example 8 | CA3 (20) | ER4 (32.25) | KTL N16 |
| Example 9 | CA3 (15) | ER5 (30.15) | None |
| Example 10 | CA3 (15) | ER5 (30.15) | KTL N16 |
| Example 11 | CA4 (10) | ER6 (29.46) | None |
| Example 12 | CA4 (10) | ER6 (29.46) | AEROSHELL TURBINE |
| | | | OIL 500 |
| Example 13 | CA4 (10) | ER6 (29.46) | SYMBOL 2190 TEP |
| Example 14 | CA4 (10) | ER7 (31.76) | AEROSHELL TURBINE |
| | | | OIL 500 |
| Example 15 | CA4 (10) | ER7 (31.76) | SYMBOL 2190 TEP |
| Example 16 | CA5 (10) | ER8 (26.6) | None |
| Example 17 | CA5 (10) | ER8 (26.6) | SYMBOL 2190 TEP |
| Example 18 | CA4 (10) | ER9 (29.46) | KTL N16 |

Examples 11, 13, 16, and 17 were evaluated for lap shear using the test method described above. The results are shown in Table 6 where the term “cohesive” denotes cohesive failure and the term “mixed mode” denotes a mixture of adhesive and cohesive failure.

TABLE 6
Lap Shear Properties.

| Example | Lap Shear Value (psi) | Failure Mode |
|---|---|---|
| Example 11 | 1259 ± 59 | Cohesive |
| Example 13 | 1095 ± 141 | Mixed Mode |
| Example 16 | 2285 ± 31 | Cohesive |
| Example 17 | 1430 ± 101 | Mixed Mode |

Examples 13 and 17 were evaluated for using the flexibility test described above with three different size cylinders. The results are shown in Table 7.

TABLE 7
Flexibility Properties

| | Failure Mode | | |
|---|---|---|---|
| | 4.5″ (114.3 mm) | 6.5″ (165.1 mm) | 11″ (279.4 mm) |
| | Diameter | Diameter | Diameter |
| Example | Cylinder | Cylinder | Cylinder |
| Example 13 | No Failure | No Failure | No Failure |
| Example 17 | Crack at center, | No Failure | Did not test |
| | coating intact | | |

Examples 11, 13, 16, and 17 were evaluated for impact properties with and without the surface oiled with SYMBOL 2190 TEP. The results are in Table 8. The presence of oil on the coatings does not affect the impact failure end point of the coatings.

TABLE 8
Impact Properties

| | | Impact failure | Impact failure |
|---|---|---|---|
| | | end point | end point |
| Example | Oil | (inch-lbs) | (m-kg) |
| Example 11 | No | 70 | 0.81 |
| Example 13 | Yes | 70 | 0.81 |
| Example 16 | No | 35 | 0.40 |
| Example 17 | Yes | 35 | 0.40 |

Examples 1 to 18 were evaluated using the scoring test described above. The results are in Table 9. None of the coatings failed at the oily metal/cured coating composition interface. Failure between coatings is presumed to be due to amine blushing.

TABLE 9
Scoring Test Results

| | Number of | |
|---|---|---|
| Example | coatings | Failure mode |
| Example 1 | 2 | Between coatings |
| Example 2 | 2 | Between coatings |
| Example 3 | 2 | Between coatings |
| Example 4 | 2 | Between coatings |
| Example 5 | 2 | Between coatings |
| Example 6 | 2 | Between coatings |
| Example 7 | 2 | Between coatings |
| Example 8 | 2 | Between coatings |
| Example 9 | 2 | Between coatings |
| Example 10 | 2 | Between coatings |
| Example 12 | 1 | No failure |
| Example 13 | 1 | No failure |
| Example 14 | 1 | No failure |
| Example 15 | 1 | No failure |
| Example 18 | 2 | No failure |

1. A curable coating composition having a first part and a second part, the curable coating composition comprising:
a) an epoxy resin in the first part of the curable coating composition;
b) a curing agent in the second part of the curable coating composition, the curing agent having at least two amino groups of formula —NR¹H where R¹ is selected from hydrogen, alkyl, aryl, or alkylaryl;
c) an oil displacing agent, wherein the oil displacing agent is soluble in the curable coating composition, has a surface tension in a range of 15 to 32 dynes/cm, and has a boiling point of at least 200° C., wherein the oil displacing agent is a glycidyl ester, mono-ester, di-ester, trialkyl phosphate, alkyl methacrylate, alkyl trialkoxy silane, alkane, or alcohol;
d) an oil absorbing fiber, wherein the oil absorbing fiber comprises 0 to no greater than 50 weight percent fibrillated organic fiber based on a total weight of the oil absorbing fiber; and
wherein the curable coating composition is free or substantially free of a toughening agent that phase separates from the other components of a cured composition formed from the curable coating composition.

2. The curable coating composition of claim 1, wherein the oil absorbing fiber is an inorganic fiber.

3. The curable coating composition of claim 1, wherein the oil absorbing fiber is free or substantially free of fibrillated organic fiber.

4. (canceled)

5. The curable coating composition of claim 1, wherein the epoxy resin comprises an epoxy phenol novolac.

6. The curable coating composition of claim 1, wherein the epoxy resin has reactive glycidyl groups and a molar ratio of glycyidyl groups in the epoxy resin to amino groups in the curing agent is in a range of 1.2:1 to 1:1.2.

7. The curable coating composition of claim 1, wherein the curable coating composition is free of essentially free of a reactive liquid modifier having acetoacetoxy groups.

8. The curable coating composition of claim 1, wherein the curable coating composition comprises 20 to 80 weight percent epoxy resin, 10 to 60 weight percent curing agent, 0.1 to 20 weight percent oil displacing agent, and 0.1 to 30 weight percent oil absorbing fibers.

9. The curable coating composition of claim 8, wherein the curable coating composition is free of fibrillated organic fiber.

10. The curable coating composition of claim 1, wherein the oil absorbing fiber has an average length that is at least 300 micrometers.

11. The curable coating composition of claim 1, wherein the curable coating composition is free or substantially free of an organic solvent having a boiling point less than 200° C.

12. The curable coating composition of claim 1, wherein the oil absorbing fibers have an oil absorbing capacity of at least 60 grams per 100 grams of fiber based on ASTM D281-95.

13. A cured coating composition comprising a reaction product of a curable coating composition comprising:
a) an epoxy resin;
b) a curing agent having at least two amino groups of formula —NR¹H where R¹ is selected from hydrogen, alkyl, aryl, or alkylaryl;
c) an oil displacing agent, wherein the oil displacing agent is soluble in the curable coating composition, has a surface tension in a range of 15 to 32 dynes/cm, and has a boiling point of at least 200° C., wherein the oil displacing agent is a glycidyl ester, mono-ester, di-ester, trialkyl phosphate, alkyl methacrylate, alkyl trialkoxy silane, alkane, or alcohol;
d) an oil absorbing fiber, wherein the oil absorbing fiber comprises 0 to no greater than 50 weight percent fibrillated organic fiber based on a total weight of the oil absorbing fiber; and
wherein the curable coating composition is free or substantially free of a toughening agent that phase separates from the other components of a cured composition formed from the curable coating composition.

14. The cured coating composition of claim 13, wherein the curable coating composition comprises 20 to 80 weight percent epoxy resin, 10 to 60 weight percent curing agent, 0.1 to 20 weight percent oil displacing agent, and 0.1 to 30 weight percent oil absorbing fibers.

15. An article comprising:
a substrate; and
a cured coating composition adjacent to the substrate, the cured coating composition comprising a reaction product of a curable coating composition comprising;
a) an epoxy resin;
b) a curing agent having at least two amino groups of formula —NR¹H where R¹ is selected from hydrogen, alkyl, aryl, or alkylaryl;
c) an oil displacing agent, wherein the oil displacing agent is soluble in the curable coating composition, has a surface tension in a range of 15 to 32 dynes/cm, and has a boiling point of at least 200° C., wherein the oil displacing agent is a glycidyl ester, mono-ester, di-ester, trialkyl phosphate, alkyl methacrylate, alkyl trialkoxy silane, alkane, or alcohol;
d) an oil absorbing fiber, wherein the oil absorbing fiber comprises 0 to no greater than 50 weight percent fibrillated organic fiber based on a total weight of the oil absorbing fiber; and
wherein the curable coating composition is free or substantially free of a toughening agent that phase separates from the other components of a cured composition formed from the curable coating composition.

16. The article of claim 15, wherein the curable coating composition comprises 20 to 80 weight percent epoxy resin, 10 to 60 weight percent curing agent, 0.1 to 20 weight percent oil displacing agent, and 0.1 to 30 weight percent oil absorbing fibers.

17. A method of coating, the method comprising:
providing a substrate;
applying a curable coating composition adjacent to the substrate, the curable coating composition comprising
a) an epoxy resin;
b) a curing agent having at least two amino groups of formula —NR¹H where R¹ is selected from hydrogen, alkyl, aryl, or alkylaryl;
c) an oil displacing agent, wherein the oil displacing agent is soluble in the curable coating composition, has a surface tension in a range of 15 to 32 dynes/cm, and has a boiling point of at least 200° C., wherein the oil displacing agent is a glycidyl ester, mono-ester, di-ester, trialkyl phosphate, alkyl methacrylate, alkyl trialkoxy silane, alkane, or alcohol;
d) an oil absorbing fiber, wherein the oil absorbing fiber comprises 0 to no greater than 50 weight percent fibrillated organic fiber based on a total weight of the oil absorbing fiber; and
wherein the curable coating composition is free or substantially free of a toughening agent that phase separates from the other components of a cured composition formed from the curable coating composition;
curing the curable coating composition to provide a cured coating composition adjacent to the substrate.

18. The method of claim 17, wherein the substrate is contaminated with a hydrocarbon-containing material.

19. The method of claim 17, wherein the curable coating composition comprises 20 to 80 weight percent epoxy resin, 10 to 60 weight percent curing agent, 0.1 to 20 weight percent oil displacing agent, and 0.1 to 30 weight percent oil absorbing fibers.
